(19) United States
(12) Patent Application Publication
(10) Pub. No.: US 2010/0330340 A1
(43) Pub. Date: Dec. 30, 2010

(54) SUPERHYDROPHOBIC SURFACES FOR DRAG REDUCTION

(75) Inventors: Jonathan P. Rothstein, Belchertown, MA (US); Robert Daniello, Florence, MA (US)

Correspondence Address: Milstein Zhang & Wu LLC, 49 Lexington Street, Suite 6, Newton, MA, 02465-1062, US

(73) Assignee: University of Massachusetts, Shrewsbury, MA (US)

(21) Appl. No.: 12/777,195

(22) Filed: May 10, 2010

Related U.S. Application Data
(60) Provisional application No. 61/177,453, filed on May 12, 2009.

(51) Int. Cl. B32B 3/30; B32B 37/00

(52) U.S. Cl. 428/167; 156/297

(57) ABSTRACT

Superhydrophobic surfaces according to the invention contain micro or nanoscale hydrophobic features which can support a shear-free air-water interface between peaks in the surface topology. The surface of an engineered structure is patterned with a plurality of parallel ridges extending from the surface. The ridges have a width d and a height h, and are spaced apart by a first spacing dimension w. The ridges extend along the surface of the solid object for a predefined length l. Breaker ridges are situated between the parallel ridges, and are oriented at an angle to the parallel ridges. The breaker ridges are preferably spaced apart by a second spacing dimension. The breaker ridges and the parallel ridges are configured to define a volume wherein a gas may be situated. The engineered structure is configured to provide a reduced drag force between itself and a fluid.

### CROSS-REFERENCE TO RELATED APPLICATIONS

This application claims priority to and the benefit of co-pending U.S. provisional patent application Ser. No. 61/177,453, filed May 12, 2009, which application is incorporated herein by reference in its entirety.

### STATEMENT REGARDING FEDERALLY FUNDED RESEARCH OR DEVELOPMENT

The U.S. Government has certain rights in this invention pursuant to Grant No. N00014-06-1-0497 awarded by Office of Naval Research.

### FIELD OF THE INVENTION

The invention relates to hydrodynamic flow systems in general and particularly to surfaces that are constructed to provide reduced hydrodynamic drag.

### BACKGROUND OF THE INVENTION

The development of technologies which produce significant drag reduction in turbulent flows can have a profound effect on a variety of existing technologies. Drag reduction in turbulent flows can be achieved through a number of different mechanisms including the addition of polymers to the fluid (see Virk, P. S., AIChE J., 21 (1975) 625-656), the addition of bubbles (see Sanders, W. C., Winkel, E. S., Dowling, D. R., Perlin, M., and Ceccio, S. L., J. Fluid Mech., 552 (2006) 353-380) or air layers (see Elbing, B., R., Winkel, E., S., Lay, K., S., Ceccio, S., L., Dowling, D., R, and Perlin, M., Journal of Fluid Mechanics, 612 (2008) 201-236; Fukuda, K., Tokunaga, J., Nobunaga, T., Nakatani, T., Iwasaki, T., and Kunitake, Y., Journal of Marine Science and Technology, 5 (2000) 123-130), compliant walls (see Hahn, S., Je, J., and Choi, H., J. Fluid Mech., 450 (2002) 259-285), and riblets (see Bechert, D. W., Bruse, M., Hage, W., van der Hoeven, J. G. T., and Hoppe, G., J. Fluid Mech., 338 (1997) 59-87). All of these techniques have drawbacks from being too expensive to implement or having a narrow range of Reynolds numbers (flow speeds) over which they are viable.

Superhydrophobic surfaces were originally inspired by the unique water repellent properties of the lotus leaf (see Quere, D., and Reyssat, M., Phil. Trans. Roy. Soc. A, 366 (2008) 1539-1556). They are rough, with micro or nanometer-sized surface features. In the Cassie state, illustrated in FIG. 1, the chemical hydrophobicity of the material prevents the water from moving into the space between the peaks of the rough surface, resulting in the air-water interface which is essentially shear free. The resulting surface possesses a composite interface where momentum transfer with the wall occurs only at the liquid-solid and not the liquid-vapor interfaces. Recent synthetic superhydrophobic surfaces have been developed which are perfectly hydrophobic, obtaining contact angles that can approach θ=180° with no measurable contact hysteresis (see Quere, D., and Reyssat, M., Phil. Trans. Roy. Soc. A, 366 (2008) 1539-1556; Gao, L., and McCarthy, T., J., Langmuir, 23 (2007) pp. 9125-9127). While the general principles that control the superhydrophobic behavior of surface are known, a significant problem is providing such surfaces having macroscopic dimensions, rather than microscopic dimensions, so that they can be used in “real world” applications.

U.S. Pat. No. 7,150,904 issued on Dec. 19, 2006 to D'Urso et al. describes a composite material having sharp surface features. The composite material includes a recessive phase and a protrusive phase. The recessive phase has a higher susceptibility to a preselected etchant than the protrusive phase. The composite material has an etched surface wherein the protrusive phase protrudes from the surface to form a sharp surface feature. The sharp surface features can be coated to make the surface super-hydrophobic.

U.S. Pat. No. 7,258,731 issued on Aug. 21, 2007 to D'Urso et al. describes a hydrophobic disordered composite material having a protrusive surface feature. The composite material includes a recessive phase and a protrusive phase. The recessive phase has a higher susceptibility to a preselected etchant than the protrusive phase. The composite material has an etched surface wherein the protrusive phase protrudes from the surface to form a protrusive surface feature that is hydrophobic.

U.S. Pat. No. 7,459,197 issued on Dec. 2, 2008 to Aizenberg et al. describes reversibly adaptive rough structures, that include a substrate and a plurality of raised elements on the substrate. The raised elements are mutually spaced apart by channel regions on the substrate. Each of the raised elements has a lateral surface and a distal end. The lateral surface, the distal end and the channel regions have hydrophobic molecules thereon. The distal end also has reversibly adaptive bristles thereon, the reversibly adaptive bristles being convertible between relatively hydrophilic and hydrophobic states by the application of an external stimulus. The patent teaches techniques for making reversibly adaptive rough structures.

U.S. Pat. No. 7,695,767 issued on Apr. 13, 2010 to Strauss et al. describes a method for providing a superhydrophobic surface on a structure, for example aircraft wings, propellers and/or rotors. The method includes applying a coating of hydrofluoric acid over a titanium substrate. A voltage is then applied across the titanium substrate so that current flows through the titanium substrate. The current flowing through the titanium substrate causes the hydrofluoric acid to react with the titanium substrate to anodize the titanium substrate. The anodization causes a nanoporous titanium oxide layer to grow across the titanium substrate. The titanium oxide layer includes a plurality of nano-tube structures that, once the remaining hydrofluoric acid is washed away, provide a microscopically rough surface on the titanium substrate. A conformal coating of a hydrophobic compound is then deposited on the microscopically rough surface to create a superhydrophobic surface. Thus, a substantially self-cleaning superhydrophobic surface is created on the titanium substrate, whereby, when exposed to ultraviolet light, the titanium oxide layer has a photocatalytic reaction with oxygen to oxidize any organic contaminants that may gather on the superhydrophobic surface.

U.S. Patent Application Publication No. 20070166464 A1, published on Jul. 19, 2007, describes a process for preparing super-hydrophobic surface compositions, to compositions obtained by said process and to the use of the compositions. The process comprises the steps of a) radical or condensation polymerisation of a reactive functional group containing monomer pair with an initiator in non-reactive solvent environment, and b) mixing the copolymer obtained in a) with a hydrocarbon/fluorinated/siloxane chemical agent having at least one end capped with reactive groups and a catalyst characterised in that it further comprises the step of c) electrospinning/electrospraying of the mixture obtained in b), and d) annealing and crosslinking of the electrospun/electrosprayed mixture.

U.S. Patent Application Publication No. 20080131653 A1, published on Jun. 5, 2008, describes an apparatus including a rigid fluid-permeable body, having a first non-planar fluid-permeable body surface, and having a second fluid-permeable body surface; a plurality of fluid-permeable cells in the fluid-permeable body; and a plurality of raised micro-scale features on the first fluid-permeable body surface. The apparatus includes a fluid-permeable body having first and second fluid-permeable body surfaces; a plurality of fluid-permeable cells in the fluid-permeable body; a plurality of raised micro-scale features on the first fluid-permeable body surface; and a fluid containment body forming, together with the second fluid-permeable body surface, a second fluid containment structure. Methods, utilizing an apparatus, of treating a liquid with a fluid, and of maintaining a superhydrophobic surface are described.

U.S. Patent Application Publication No. 20090011222 A1, published on Jan. 8, 2009, describes a method of applying Lotus Effect materials as a (superhydrophobicity) protective coating for various system applications, as well as the method of fabricating/preparing Lotus Effect coatings.

U.S. Patent Application Publication No. 20090260702 A1, published on Oct. 22, 2009, describes a method for manufacturing a solid body having a superhydrophobic surface structure formed by using a surface treatment of a metal body, a replication process, and a polymer sticking phenomenon to increase efficiency of fluid transfer and prevent foreign materials from being accumulated in the tube, and a superhydrophobic fluid transfer tube using the method. The superhydrophobic fluid transfer tube includes a fluid guider and a solid body provided on a fluid contact surface of the fluid guider and has micrometer-scaled unevenness and nanometer-scaled protrusions. In the method, a plurality of nanometer-scaled holes are formed on a surface of a metal body through an anodizing process, a replica is formed by immersing the metal body provided with the nanometer-scaled holes in a non-wetting polymer material and solidifying the non-wetting polymer material, the solid body having the superhydrophobic surface is formed by removing the metal body and an anode oxide from the replica, and the solid body is provided to a fluid contact surface of a fluid guider for guiding a fluid.

U.S. Patent Application Publication No. 20090317590 A1, published on Dec. 24, 2009, describes a method of processing a superhydrophobic surface and a solid body having the superhydrophobic surface processed by the method. The method forming a plurality of nano-scale holes having nano-scale diameter on a surface of a metal body through an anode oxidation process, forming a replica by immersing the metal body provided with the nano-scale holes in a hydrophobic polymer material and solidifying the hydrophobic polymer material, and forming the superhydrophobic surface by removing the metal body with an anode oxide. The solid body includes a base, and a surface structure having micro-scale unevenness formed by a plurality of bunches formed by a plurality of adjacent pillars that are formed on the base and have a nano-scale diameter.

U.S. Patent Application Publication No. 20100028615 A1, published on Feb. 4, 2010, describes a method of processing a superhydrophobic surface and a solid body having the superhydrophobic surface processed by the method. The method includes orienting a spray nozzle of a particle sprayer toward a surface of a metal body, operating the particle sprayer to forming micro-scale protrusions and depressions on the surface of the metal body by spraying particles to the surface of the metal body, forming a plurality of nano-scale holes on the surface of the metal body by treating the metal body through an anodic oxidation process, forming a replica by immersing the metal body in a non-wetting polymer material and solidifying the non-wetting polymer material, and forming a superhydrophobic dual-scaled surface structure having nano-scale pillars formed on micro-scale protrusions and depressions by removing the metal body and an anodic oxide from the replica.

There is a need for systems having superhydrophobic surfaces of macroscopic dimensions, and for methods of producing such superhydrophobic surfaces with macroscopic dimensions.

### SUMMARY OF THE INVENTION

In one aspect, the invention relates to an engineered structure configured to provide reduced drag force experienced by a solid object and a fluid having relative motion therebetween. The engineered structure comprises a surface of the solid object; a plurality of parallel ridges extending from the surface of the solid object, the plurality of parallel ridges each having a width d and a height h, the plurality of parallel ridges being spaced apart by a first spacing dimension w, the plurality of parallel ridges extending along the surface of the solid object for a predefined length; and at least two breaker ridges situated between at least two of the plurality of parallel ridges, the at least two breaker ridges being oriented at an angle to the length of the at least two parallel ridges, the at least two breaker ridges being situated apart from each other by a second spacing dimension, the at least two breaker ridges and the plurality of parallel ridges configured to define a volume wherein a gas may be situated. The engineered structure is configured to provide a reduced drag force between the fluid and the solid object having the engineered structure when the fluid and the solid object are in a relative flow relationship as compared to a drag force that would be generated between the fluid and the solid object lacking the engineered structure when the fluid and the solid object are in a relative flow relationship.

In one embodiment, the fluid is water. In one embodiment, the fluid is sea water. In one embodiment, the fluid is fresh water. In one embodiment, the gas situated between the plurality of parallel ridges and the at least two breaker ridges is air. In one embodiment, the gas situated between the plurality of parallel ridges and the at least two breaker ridges is water vapor.

In one embodiment, the engineered structure further comprises at least one aperture defined within the surface of the solid object, and a source of pressurized gas configured to provide the gas to the volume defined by the at least two breaker ridges and the plurality of parallel ridges. In one embodiment, the engineered structure further comprises a pressure monitoring device configured to measure a pressure of the gas. In one embodiment, the engineered structure further comprises a pressure control device configured to control a pressure of the gas. In some embodiments, the second spacing dimension being at least a selected one of two, five, ten or more times greater than the first spacing dimension w.

In another aspect, the invention features an engineered structure configured to provide reduced drag force experienced by a solid object and a fluid having relative motion therebetween. The structure comprises a surface of the solid object; a plurality of posts extending from the surface of the solid object, the plurality of posts each having a width d and a height h, the plurality of posts being spaced apart by a first spacing dimension w, the plurality of posts extending along the surface of the solid object in a first direction for a predefined distance; and at least two breaker posts situated between at least two of the plurality of posts, the at least two breaker posts being oriented along a line inclined at an angle to the first direction, the at least two breaker posts being situated apart from each other by a second spacing dimension, the second spacing dimension being at least a selected one of two, five, ten or more times greater than the first spacing dimension w, the at least two breaker posts and the plurality of posts configured to define a volume wherein a gas may be situated. The engineered structure is configured to provide a reduced drag force between the fluid and the solid object having the engineered structure when the fluid and the solid object are in a relative flow relationship as compared to a drag force that would be generated between the fluid and the solid object lacking the engineered structure when the fluid and the solid object are in a relative flow relationship.

In one embodiment, the fluid is water. In one embodiment, the fluid is sea water. In one embodiment, the fluid is fresh water. In one embodiment, the gas situated between the plurality of posts and the at least two breaker posts is air. In one embodiment, the gas situated between the plurality of posts and the at least two breaker posts is water vapor.

In one embodiment, the engineered structure further comprises at least one aperture defined within the surface of the solid object, and a source of pressurized gas configured to provide the gas to the volume defined by the at least two breaker posts and the plurality of posts. In one embodiment, the engineered structure further comprises pressure monitoring device configured to measure a pressure of the gas. In one embodiment, the engineered structure further comprises a pressure control device configured to control a pressure of the gas.

In yet another aspect, the invention provides a method of manufacturing an engineered structure configured to provide reduced drag force experienced by a solid object and a fluid having relative motion therebetween. The method comprises the steps of providing a solid object having a surface; proving on the surface of the solid object a plurality of parallel ridges extending from the surface of the solid object, the plurality of parallel ridges each having a width d and a height h, the plurality of parallel ridges being spaced apart by a first spacing dimension w, the plurality of parallel ridges extending along the surface of the solid object for a predefined length; and providing on the surface of the solid object at least two breaker ridges situated between at least two of the plurality of parallel ridges, the at least two breaker ridges being oriented at an angle to the length of the at least two parallel ridges, the at least two breaker ridges being situated apart from each other by a second spacing dimension, the second spacing dimension being at least a selected one of two, five, ten or more times greater than the first spacing dimension w, the at least two breaker ridges and the plurality of parallel ridges configured to define a volume wherein a gas may be situated.

In one embodiment, the parallel ridges and the breaker ridges are provided on a sheet substrate, and the sheet substrate is attached to the surface of the solid object.

In still another aspect, the invention relates to a method of manufacturing an engineered structure configured to provide reduced drag force experienced by a solid object and a fluid having relative motion therebetween. The method comprises the steps of providing a solid object having a surface; providing on the surface of the solid object a plurality of posts extending from the surface of the solid object, the plurality of posts each having a width d and a height h, the plurality of posts being spaced apart by a first spacing dimension w, the plurality of posts extending along the surface of the solid object in a first direction for a predefined distance; and providing on the surface of the solid object at least two breaker posts situated between at least two of the plurality of posts, the at least two breaker posts being oriented along a line inclined at an angle to the first direction, the at least two breaker posts being situated apart from each other by a second spacing dimension, the second spacing dimension being at least a selected one of two, five, ten or more times greater than the first spacing dimension w, the at least two breaker posts and the plurality of posts configured to define a volume wherein a gas may be situated.

In one embodiment, the posts and the breaker posts are provided on a sheet substrate, and the sheet substrate is attached to the surface of the solid object.

The foregoing and other objects, aspects, features, and advantages of the invention will become more apparent from the following description and from the claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1A is a schematic diagram of air trapped between hydrophobic microfeatures of a superhydrophobic surface. The air water interface produces shear free regions resulting in a reduction in wetted area and regions that can experience significant slip in flows.

FIG. 1B is a micrograph of a superhydrophobic microridge geometry containing 60 μm wide ridges spaced 60 μm apart, whose features are approximately 25 μm deep.

FIG. 2A is an SEM image of a superhydrophobic surface design according to principles of the invention which includes breaker ridges, here running diagonally from the upper left to the lower right, to make surfaces more robust.

FIG. 2B is one schematic diagram of superhydrophobic designs according to principles of the invention with breaker ridges used for arrays of ridges in the flow direction or posts.

FIG. 2C is another schematic diagram of superhydrophobic designs according to principles of the invention with breaker ridges used for arrays of ridges in the flow direction or posts.

FIG. 2B and FIG. 2C are just two illustrative examples of possible surface designs.

FIG. 3 is a diagram showing the coefficient of friction for various surfaces calculated from both PIV and pressure measurements. Smooth surfaces (Δ) and superhydrophobic surfaces containing w=30 μm wide microridge spaced d=30 μm apart () are shown for PIV measurements of a channel with a single superhydrophobic wall. Pressure drop measurements from channels with two smooth walls (star) and two superhydrophobic walls containing w=30 μm and d=30 μm microridges (∘) and w=60 μm d=60 μm microridges (▪) are also shown. The predictions of the friction coefficient for a smooth channel is also shown (-) in both the laminar and turbulent regimes. Transition occurs around Re=2100.

FIG. 4 is an illustration of water and ethanol droplets resting on a superhydrophobic surface.

FIG. 5A is a schematic diagram showing a cross section of a flow cell used for PIV with a PDMS superhydrophobic surface on the bottom and a smooth acrylic surface on top. The bottom surface was interchangeable and was replaced with a number of different superhydrophobic PDMS surfaces.

FIG. 5B is a diagram in perspective of the flow cell of FIG. 5A.

FIG. 6 is a schematic diagram showing a cross section of a flow cell used for pressure drop measurements. Superhydrophobic surfaces were fitted to both the top and the bottom surfaces of the channel.

FIG. 7A is a diagram showing velocity profiles over a microridge surface having w=60 μm and d=60 μm showing the development of significant slip velocities with increasing Reynolds number from 2700 (Δ) to 8200 (▪). The inset shows velocity profiles near the wall demonstrating prominent slip velocities. Reynolds numbers are: 2700 (Δ), 3900 (▴), 4840 (⋄), 5150 (♦), 6960 (□), 8200 (▪). For clarity, the modified Spalding fits (□) from Equation 3 are only overlaid on the profiles corresponding to Re=2700 and Re=8200.

FIG. 7B is a diagram showing velocity profiles over the w=30 μm and d=30 μm microridge surface demonstrate slip velocity behavior consistent with that observed on the 60-60 surface, but reduced in magnitude. Reynolds numbers range from 4970 (∘) to 7930 (∇). Larger feature spacing performs better for a given Reynolds number. Reynolds numbers are: 4970 (∘), 5400 (♦), 6800 (Δ), 7160 (▪), 7930 (∇) The modified Spalding fits (□) are overlaid on the profile corresponding to Re=7930.

FIG. 8 is a diagram showing the results of pressure drop measurements for flow through a rectangular channel with a smooth walls (Δ) and with two walls containing superhydrophobic microridges with w=60 μm and d=60 μm (▪). The Colebrook line (-) is shown for a smooth channel.

FIG. 9 is a diagram showing the wall shear stress measured from PIV as a function of Reynolds number for a channel with a single superhydrophobic surface. Results are presented for both the smooth top wall (Δ) and the superhydrophobic bottom wall containing w=30 μm wide ridges spaced d=30 μm apart (). Drag reduction is seen only on the superhydrophobic wall, the smooth wall being in good agreement with the Colebrook prediction for a smooth channel (-).

FIG. 10A is a diagram showing the drag reduction as a function of Reynolds number for a channel with a single superhydrophobic wall w=30 μm d=30 μm ().

FIG. 10B is a diagram showing the drag reduction as a function of Reynolds number for a channel with two superhydrophobic walls containing w=30 μm and d=30 μm microridges (∘) and w=60 μm and d=60 μm microridges (▪).

FIG. 11 is a diagram in which the microridge spacing is presented in wall units, w⁺, as a function of Reynolds number. The data are taken from PIV measurements from a channel with a single superhydrophobic surface of w=30 μm and d=30 μm microridges () and from pressure measurements for flow through a channel with two superhydrophobic walls containing w=30 μm and d=30 μm microridges () and w=60 μm and d=60 μm microridges (▪). A spacing of w⁺=5 corresponds to the thickness of the viscous sublayer. Only points in the turbulent regime are shown.

FIG. 12 is a diagram showing pressure drop per unit length vs. Reynolds number for various structures, which are compared to theory.

FIG. 13 is a diagram showing drag reduction vs. Reynolds number for various structures, which are compared to superlaminar flow (theory).

FIG. 14 is a diagram of the relationship of a viscous sublayer to a surface according to principles of the invention, as a function of Reynolds number.

FIG. 15 is a diagram of the relationship between wall units, w⁺, as a function of Reynolds number, for different structures having d=w=30 μm and d=w=60 μm.

FIG. 16 is a diagram of the relationship between normalized shear stress as a function of Reynolds number, for different structures having d=w=15 μm and a smooth structure.

FIG. 17 is a diagram showing drag reduction vs. wall units, w⁺, for various structures having d=w=15 μm, d=w=30 μm and d=w=60 μm.

FIG. 18 is a diagram showing the drag reduction for repeated measurements of a surface having d=w=15 μm as compared to a smooth surface.

### DETAILED DESCRIPTION

We have recently demonstrated that superhydrophobic surfaces can be used as a new passive technique for reducing drag over a wide range of Reynolds numbers from laminar (see Ou, J., Perot, J. B., and Rothstein, J. P., Phys. Fluids, 16 (2004) 4635-4660; Joseph, P., Cottin-Bizonne, C., Benoit, J.-M., Ybert, C., Journet, C., Tabeling, P., and Bocquet, L., Phys. Rev. Lett., 97 (2006) 156104) to turbulent flows (see Martell, M. B., Perot, J. B., and Rothstein, J. P., J. Fluid Mech., 620 (2009) 31-41; Daniello, R., Waterhouse, N. E., and Rothstein, J. P., Submitted to Phys. Fluids, (2009), unpublished).

We demonstrate that periodic, micropatterned superhydrophobic surfaces, previously noted for their ability to provide laminar flow drag reduction, are capable of reducing drag in the turbulent flow regime. Superhydrophobic surfaces contain micro or nanoscale hydrophobic features which can support a shear-free air-water interface between peaks in the surface topology. Particle image velocimetry and pressure drop measurements were used to observe significant slip velocities, shear stress, and pressure drop reductions corresponding to drag reductions approaching 50%. At a given Reynolds number, drag reduction is found to increase with increasing feature size and spacing, as in laminar flows. No observable drag reduction was noted in the laminar regime, consistent with previous experimental results for the channel geometry considered. The onset of drag reduction occurs at a critical Reynolds number where the viscous sublayer thickness approaches the scale of the superhydrophobic microfeatures and performance is seen to increase with further reduction of viscous sublayer height. These results indicate superhydrophobic surfaces can provide a significant drag reducing mechanism for marine vessels.

The expected benefits of drag reduction are expected to include a reduction in the pressure drop in pipe flows, reduced drag on objects moving in a fluid (such as marine vessels in water), reduced stress on static submersed objects such as moorings, and reduced friction on a bathing suit, for example for competition swimmers. Reduced drag on marine vessels can provide an increase in fuel efficiency and speed, and reductions in cost of operation.

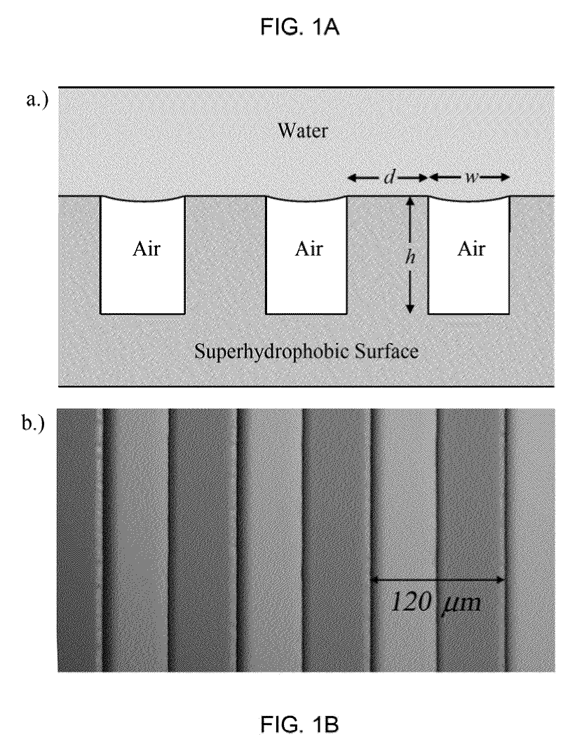

Ou and Rothstein (see Ou, J., Perot, J. B., and Rothstein, J. P., Phys. Fluids, 16 (2004) 4635-4660; Ou, J., and Rothstein, J. P., Phys. Fluids, 17 (2005) 103606) among others demonstrated that superhydrophobic surfaces produce drag reduction and an apparent slip at the wall in laminar flows as a direct result of the shear-free air-water interface supported between surface microfeatures. Few experimental studies have considered superhydrophobic drag reduction into the turbulent regime (see Gogte, S., Vorobieff, P., Truesdell, R., Mammoli, A., van Swol, F., Shah, P., and Brinker, C. J., Physics of Fluids, 17 (2005); Henoch, C., Krupenkin, T. N., Kolodner, P., Taylor, J. A., Hodes, M. S., Lyons, A. M., Peguero, C., and Breuer, K., Collection of Technical Papers—3rd AIAA Flow Control Conference, 2 (2006) p 840-844; Watanabe, K., Yanuar, and Udagawa, H., J. Fluid Mech., 381 (1999) 225-238; Balasubramanian, A., K., Miller, A., C., and Rediniotis, O., K., AIAA Journal, 42 (2003) 411-414). All but our recent experiments have used superhydrophobic surface with random surface roughness. Our surfaces are precisely designed and fabricated with periodic arrays of hydrophobic posts or ridges sticking up out of the surface and supporting a shear-free air-water interface as shown in FIG. 1A.

FIG. 1A is a diagram showing how air trapped between hydrophobic microfeatures creates a superhydrophobic surface. The air water interface produces shear free regions resulting in a reduction in wetted area and regions that can experience significant slip in flows.

In order to maximize the drag reduction achieved using superhydrophobic surfaces, one needs to reduce the density of ridges or posts by either reducing their size or increasing the spacing between them, or both. There is, however, is a practical limit on the post or ridge density. There is a maximum static pressure that can be supported before the air-water interfaces are driven into the space between the surface roughness and the surface features are fully wet thereby destroying their performance. Using Young's law and assuming an interface with a single radius of curvature such as that which exists between two parallel ridges, we find that the pressure differential, or static pressure Δpₘₐₓ, is given by Eqn. (1)

$$Δ {p}_{m ax} = {p}_{water} - {p}_{air} = - \frac{2 γ cos {θ}_{A}}{w} . \qquad Eqn . ( 1 )$$

This relation tends to limit the static pressure and the water depth to which these surfaces can be used effectively. Additionally, this limitation also makes these surface prone to failure if they are accidentally damaged or if an imperfection is introduced during fabrication. As an example, consider a surface composed of a series of ridges. If the surface is operating near the maximum static pressure it can maintain and then one ridge is removed, the spacing between adjacent ridges will double, thereby reducing the maximum pressure it can support. The air-water interface will advance into the space between the ridges and flood it for the entire length of the ridge, thereby locally eliminating the effectiveness of the surface for drag reduction. A surface with posts is even more fragile as the loss of a single post can flood an entire surface because the valleys between posts are continuous over the whole surface. In a typical macroscopic application where the length of the ridges could be measured in centimeters, or meters, the likelihood of such an injury to a ridge is quite large, and it would be expected that the drag reduction observed would quickly degrade for a “real world” surface having dimensions longer than even millimeters.

Our invention involves the provision of a specific feature which may be applied to any existing superhydrophobic surface design, including those in the above referenced papers. To the inventors' understanding, there have been no superhydrophobic surfaces, other than our own, which incorporate the novel feature we describe below.

Our invention constitutes a novel improvement to superhydrophobic surface design which makes the surface more robust, less prone to catastrophic damage and capable of supporting significantly larger static or dynamic pressures, including providing superhydrophobic surfaces that can attain macroscopic dimensions, thereby increasing the range of applications and uses for superhydrophobic drag reduction. Our design is quite simple. There is a large difference for drag reduction if a ridge is aligned in the flow direction or normal to the flow direction. In laminar flow, if the ridges are aligned with the flow, they are twice as effective as ridges aligned against the flow direction (see Lauga, E., and Stone, H. A., J. Fluid Mech., 489 (2003) 55-77). In turbulent flow, ridges aligned normal to the flow direction actually increase drag (see Min, T., and Kim, J., Phys. Fluids, 16 (2004) L55-L58) while ridges aligned in the flow direction can greatly reduce drag up to 50% in some cases (see Danielle, R., Waterhouse, N. E., and Rothstein, J. P., Submitted to Phys. Fluids, (2009)).

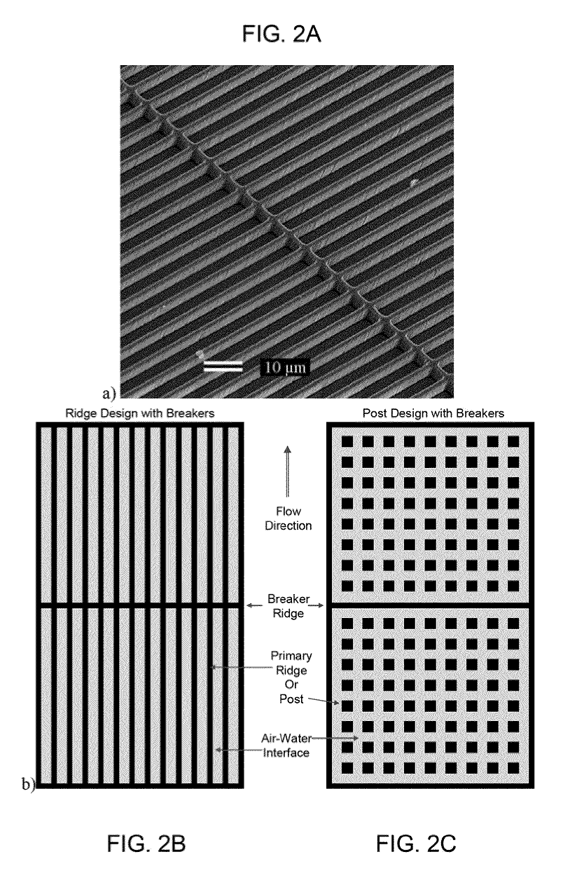

Our surface design incorporates both ridges in the flow direction and normal to it as seen in FIG. 2A. We call the ridges across the flow direction, breaker ridges. One breaker ridge is illustrated schematically in FIG. 2B and can be seen in FIG. 2A running from the upper left to the lower right in the image. FIG. 2A is an SEM image of a superhydrophobic surface design which includes breaker ridges, here running diagonally from the upper left to the lower right, to make surfaces more robust. The closely spaced primary superhydrophobic microridges run parallel to the flow. The breaker ridges can be spaced at any convenient distance from each other. In some cases, the breaker ridges are situated apart from each other by a spacing dimension that is at least a selected one of two, five, ten or more times greater than the spacing dimension between the ridges in the flow direction.

FIG. 2B is a schematic diagram of superhydrophobic designs with breaker ridges used for arrays of ridges in the flow direction or posts. FIG. 2C is another schematic diagram of superhydrophobic designs according to principles of the invention with breaker ridges used for arrays of ridges in the flow direction or posts. The illustrative examples in FIG. 2B and FIG. 2C are just two examples of many possible surface designs.

The more plentiful ridges running parallel to the flow direction are the primary superhydrophobic microfeatures. In the general sense, the breaker ridge may be any structure with a streamwise spacing much greater than spanwise superhydrophobic microfeature spacing that intentionally blocks streamwise continuity of the shear free interface on a superhydrophobic surface. The breaker ridges preferably are positioned at intervals of at least ten times the spacing between the primary ridges aligned in the flow direction. The relatively low density of breaker ridges means that they have very little impact of the drag reduction of the surface, but have a significant impact on the ability of the surface to maintain the air-water interface near the top of the channels, which is important for the purpose of these surfaces.

The novelty of this design is that the breaker ridges will isolate any failure of interface between the primary ridges to the region between two breaker ridges. Thus for a surface as in FIG. 2A or FIG. 2B with ridges spaced 10 microns apart, failures can be isolated to regions as small as 100 microns long. For a surface on the hull of a ship which can be hundreds of meters long, these isolated failures will have little to no effect on the overall drag reduction of the surface. Without the breakers, the entire hundreds of meters of surface would be affected by even the smallest scratch. That is, once the superhydrophobic nature of a channel devoid of breaker ridges fails, the entire length of the channel from the point of failure onward suffers as a result of the failure.

Breaker ridges trap the air within a cavity closed on all sides other than the surface where the water is flowing. Because the air has nowhere to go, any deformation of the air-water interface will compress the trapped air and raise the pressure within the cavity. From Boyle's Law, which states that the pressure times the volume of an ideal gas is a constant, an increase in air pressure will result in a decrease in the volume of the air in the cavity, Pₐᵢᵣ∝1/Vₐᵢᵣ. Charles' Law (PV=nRT) gives the same result if the temperature T does not change. For many purposes, air is a convenient gas to use in carrying out the principles of the invention and in operating systems and devices according to the invention. Thus a 10% reduction in the cavity size will increase the cavity pressure by 10%. For a very deep cavity a modest displacement of the air-water interface does not have much of an effect, but for ridges which are roughly as deep as they are spaced apart, this can have a significant effect. Additionally, this means that even under high pressure, the air can be compressed, but is not lost. Without the breakers it could be driven out at the open ends of the ridge, however far apart the ends may be. Additionally, the breaker ridges have shown some tendency to allow the surfaces to regenerate, that is, spontaneously and autonomously transitioning from the Wetzel (fully wetted) state back into the Cassie state. We have seen that the result is a surface which can lose its air-water interface temporarily, but then rejuvenate it with time returning the prior effectiveness of the surface. Further study of this observation is planned to quantify the effect and determine the physical mechanism. We have not been observed this tendency to occur in the absence of breaker ridges. While the present discussion makes reference to air as the gas, it should be understood that other gases, such as nitrogen, inert gases such as helium or argon, and mixtures of gases can be employed in the invention, including supplying such gases from a source at controlled pressure and delivery rate.

An additional benefit of these breaker ridges is that they make the surfaces more robust. We are currently fabricating our surfaces out of polydimethylsiloxane (PDMS) and silicon. However, it is expected that the same technology would apply to any material, be it plastic, metal or any thing else you can imagine with the same geometric surface patters. PDMS is a rubber with a relatively large elastic modulus. Even so, in a turbulent flow the shear stress and pressure fluctuations can significantly deform the ridges or posts especially in high Reynolds number flows or when the ridges or posts are reduced in size. By adding the breaker ridges, the primary ridges are converted from individual ridges to a box section which is significantly stronger and less likely to deform or buckle.

A third benefit of the addition of the breaker ridge is that it enables the development of novel techniques to use high-pressure air to back-pressurize the air-water interface. By increasing the pressure of the air trapped between the ridges or posts, for example by providing a supply of pressurized air through apertures defined in the bottom surface of the channels (such as from a pump or pressurized supply of air) the effectiveness of these drag reducing superhydrophobic surfaces can be extended to applications where large static pressures in the water are experienced. This includes deep submersible vehicles like submarines or the inside of pipes. Without using back pressurization, the water would fully wet the superhydrophobic surface in these applications. Considering Eqn. (1), this can be understood by recognizing that as p_{water} is increased, an equivalent increase in pₐᵢᵣ will maintain the static pressure Δpₘₐₓ at the same value.

Various procedures are possible for back pressurizing the air-water interface so that it could survive submersion to large depths under high static pressures. The use of back-pressurization is analogous in practice to providing pressurized air for operation of an air hockey table, so as to suspect the air hockey puck at a small distance above the table surface, thereby reducing the drag experienced by the air-hockey puck. This technique can also allow one to tune the amount of back pressurization so that the interface can be kept flat even as the static pressure changes. In other words, for a structure having appreciable depth, such as the supports of a deep sea drilling platform or the surface of a dam that is used to hold back a body of water, one can increase the air pressure as one goes deeper into the water to maintain a fixed interface position independent of depth below the surface. It is well known that water provides an increase of approximately one atmosphere of pressure for each 32 feet of depth. Additionally, the use of an air supply having a controlled pressure that is provided by apertures defined in the surface would allow one to select and maintain a desired (perhaps an optimal) deflection of the air-water interface. One can contemplate that it might prove useful to have a flat interface or slightly a convex interface (e.g., one bulging slightly outward into the flow) to tailor the drag reduction between the surface and the liquid. In addition, in some embodiments, the back-pressurized air could be used to drive bubbles into the water producing additional drag reduction, or possibly cleaning the surfaces if they get contaminated.

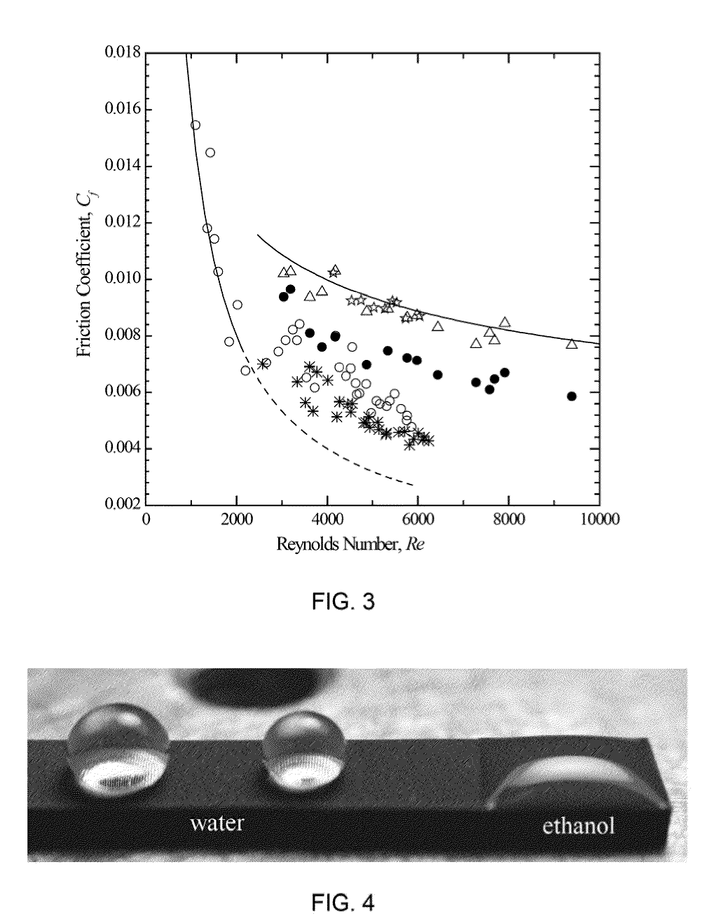

We show in FIG. 3 how effective our surfaces can be in reducing drag in turbulent flows. FIG. 3 is a graph showing the coefficient of friction for various surfaces calculated from both PIV and pressure measurements. Smooth surfaces (triangles Δ) and superhydrophobic surfaces containing w=30 μm wide microridge spaced d=30 μm apart (solid circles ) are shown for PIV measurements of a channel with a single superhydrophobic wall. Pressure drop measurements from channels with two smooth walls (star) and two superhydrophobic walls containing w=30 μm and d=30 μm microridges (open circle ∘) and w=60 μm d=60 μm microridges (asterisk *) are also shown. The predictions of the friction coefficient for a smooth channel is also shown (solid line -) in both the laminar and turbulent regimes. Transition occurs around Re=2100.

In FIG. 3, the wall shear stresses, τ_{w}, calculated from the Spalding fit to the velocity profiles and from pressure measurements of smooth, 30-30 and 60-60 channels are non-dimensionalized to form a coefficient of friction, C_{f}=2τ_{wall}/ρU², and plotted as a function of Reynolds number. For comparison, the Colebrook prediction of friction coefficient for the present perfectly smooth channel is superimposed over the data in FIG. 3. Friction coefficient was selected to account for small variations in channel height existing between the pressure drop and PIV experiments. As previously indicated, the friction coefficients of the smooth wall, calculated from PIV, and that of the smooth channel, determined from pressure drop, are in good agreement with each other as well as with the Colebrook prediction. At low Reynolds numbers, in the absence of any quantifiable slip at the superhydrophobic wall, the coefficient of friction for all cases tracks with that of the smooth-walled channel. At larger Reynolds numbers, where slip velocities are observed, the coefficients of friction of the superhydrophobic surfaces were found to lie well below those of the smooth channels. The drag reduction was found to increase with increasing Reynolds number, becoming more significant for Re>5000 as observed in the pressure measurements. The PIV measurements of the channel with a 30-30 superhydrophobic microridge surface on one wall and a smooth no-slip surface on the opposing wall show a somewhat smaller drag reduction than that which is noted by pressure drop along with two superhydrophobic walls. This result is likely due to differences in the flowcell geometry, specifically, the presence of the smooth wall in the Ply measurements, which was necessary to have transparency for flow visualization. The smooth wall has a higher wall shear stress than the superhydrophobic surface resulting in an asymmetric velocity profile and an increase in the turbulence intensity near the smooth wall. We also made these observations for a DNS of channel flow with a single superhydrophobic wall. Observed drag reductions and slip velocities are in good agreement with predictions for a DNS at Re_{τ}=180, corresponding to an experimental Re=5300 in the PIV data. DNS slightly over predicts slip velocity, and slightly under predicts drag reduction at 11% and reports enhanced performance with increasing microfeature size, as observed in the experiments. It should also be noted that DNS does not include interface deflection or compliance effects. Drag reduction calculated from PIV data are in excellent agreement with the slip length boundary condition DNS of Min and Kim and predictions of Fukagata et al. for streamwise slip. Both groups reported approximately 21% drag reduction at the same dimensionless slip length and friction Reynolds number observed in the present experiments at Re=5300. Given the challenges of directly matching DNS and experiments, these results are quite encouraging.

As can be seen, a drop of approximately 50% in the friction coefficient (drag force) is seen for one specific surface design. It is important to note that we spent two years attempting to achieve results like these for surfaces that did not have breaker ridges, but had identical primary ridges as those shown in FIG. 3. The results were wildly inconsistent; working one day/minute and not the next. Since we have incorporated our breaker ridge design, we have been able to consistently and reproducibly obtain drag reduction results. Additionally, although there are a number of other groups in the world trying to produce similar results, without our breaker ridge innovation, they have all failed to date. Thus this design modification appears to be the key to making these surfaces work.

### Additional Embodiments and Manifestations of the Invention

The superhydrophobic surfaces described above refer to the specific patterns that have been tested, but do not include all possible designs utilizing the invention. We now consider several benefits and advantages that the invention provides.

### 1. Size

All surfaces tested to date have had ridges or posts in the range of 15 μm≦d≦60 μm and 15 μm≦w≦60 μm. This is not the physical limit of possible sizes. The spacing between surface features, w, may take on any value from nanometer scales up to about 100 μm. The spacing between features, d, likewise may be nanometers to hundreds of microns. Unlike spacing between features, the width of the features has no pressure dependence and therefore no physical upper limit although performance will drop off significantly for spacings much smaller than the width of the features.

### 2. Breaker Ridge Design

The novel breaker ridge design need not take the exact form shown in FIG. 2. It need only block the otherwise uninterrupted streamwise shear free air-water interface at intervals much larger than the principal microfeature spacing. There are a limitless number of individual geometries that could accomplish this. The breaker ridge would still function if at a diagonal to the principle superhydrophobic microridges. It could also be staggered, e.g. a breaker at a different streamwise location between each principal microridge. It could even take the form of a post or other structure filling most but not all of the space between microridges, although such a breaker would likely lack several of the benefits noted for full breaker ridges.

### 3. Design of Primary Superhydrophobic Surface

Presently, the breaker ridge concept has been applied to only microridge superhydrophobic surfaces although in principle it could be applied to other surfaces patterns, including microposts as seen in FIG. 2 or by being superimposed over superhydrophobic surfaces with random surface roughness like the lotus leaf.

### 4. Flow Direction

In the results presented, flow direction or streamwise direction, and primary microridge alignment were substantially parallel, e.g., the ridges were aligned along the direction of mean flow. In applications outside the laboratory, it is possible that these surfaces will be subjected to flows that are not perfectly aligned with the primary microridge direction. It is expected that they will continue to function and the affect of slightly misaligned flow should be small if the angle of misalignment is small.

### 5. Installation or Manufacture of Surfaces

From our conversations with people in the shipping and coatings industry, it is clear that developing techniques for applying these surfaces to ships or pipes is critical. We have demonstrated the ability to fabricate these surfaces using a number of lithographic techniques. An adhesive is subsequently applied to the back of the superhydrophobic coating so that it can be affixed to the desired surface. A number of other techniques which have already been demonstrated to be successful are also applicable here. We have also demonstrated the ability to produce these surfaces using reel-to-reel technology to fabricate long continuous sheets with the desired surface patterns. It is expected that an adhesive backing can be applied to these sheets, thereby turning these superhydrophobic surfaces into a peel and stick coating or a superhydrophobic wallpaper. Additionally, we have envisioned the use of sacrificial geometries to molds-coat ships in the yard. It is expected that the sacrificial layer can be removed with a solvent (preferably water). It is expected that one can apply a hydrophobic base coating, for example by spraying onto the hull of a ship followed by the application of a sacrificial film with the desired surface pattern either by pressing into the uncured coating a film from a roll or vacuum bagging the entire hull. The sacrificial film would be removed after the coating had cured. The sacrificial mold structures could also be formed by long thin rods or thread-like structures suspended in the base coating that are aligned on the hull of the ship using flow-coating techniques, shear oriented, and then dissolved away the thread-like structures, leaving rectangular holes with the breaker ridges built in by the process. Additionally, rather than fabricating sheets with the proper geometry and applying them, the pattern can be rolled directly onto a surface by spraying the base coating onto the surface and using a roll with the desired microfeatures to apply the patter directly onto the surface, and curing as the rolling process is applied. Depending on the composition of the base coating, curing could be accomplished by application of heat, application of optical radiation (such as infrared or ultraviolet illumination), or u chemical curing (as by applying a catalyst, polymerization initiator, or second composition of a two part epoxy).

While the invention is striking in its simplicity, it is expected to provide appreciable utility and is expected to have broad application. The use of the breaker ridge structure makes the superhydrophobic surface more robust and capable of being applied to every surface vessel or submarine in use today. The 50% or more drag reduction could make the world's fleet of commercial or military vessels more fuel efficient and/or faster. The specific design features that are described herein differ significantly from all prior publications known to the inventors. The inclusion of breaker ridges on the surfaces described has greatly increased the reliability of the surfaces and has introduced the “regeneration” behavior described above.

The applications that are contemplated include the use of ridged structures having breaker ridges for marine vessels, to line pipes to provide reduced pressure drops, and in various examples of the relative flow of water past a surface. In addition, if the chemistry is changed to make a surface lyophobic, the principles of the invention are additionally expected to be useful to reduce drag in the relative flow of any liquid, not just water, past a surface of interest. The term “relative flow” is intended to denote any of: 1) a solid object moving in a fluid; 2) a fluid moving past a solid object; or 3) relative motion of both the fluid and the solid object when both are moving.

The inventors additionally recognize that in some embodiments, complete coverage of the surface is not necessary. Even partial coverage of a surface of interest with structures configures to reduce drag as described herein will result in drag reduction in proportion to the amount of surface covered. Thus for 50% drag reduction and 50% surface coverage, one would expect that approximately a 25% overall drag reduction can still be achieved.

Philip and Lauga and Stone provide analytical solutions for laminar Poiseuille flows over alternating slip and no slip boundary conditions, such as those existing above a submerged superhydrophobic surface. These results provide an analytical solution predicting and quantifying drag reduction resulting from slip/no-slip walls, in laminar flows. Ou and Rothstein demonstrated that superhydrophobic surfaces produce drag reduction and an apparent slip, corresponding to slip lengths of b=25 μm, at the wall in laminar flows as a direct result of the shear-free air-water interface between surface microfeatures. Here the slip length is defined using Navier's slip model where the slip velocity, u₀, is proportional to the shear rate experienced by the fluid at the wall

$${u}_{0} = b \frac{\partial u}{\partial y} \qquad Eqn . ( 2 )$$

These results have been extended to a variety of superhydrophobic surface designs and flow geometries. A thorough overview of the no slip boundary condition is given by Lauga et al. Ybert et al. examined scaling relationships for slip over superhydrophobic surfaces. For a superhydrophobic surface in the Cassie state, they showed slip length to increase sharply with decreasing solid fraction and increasing effective contact angle. However, Voronov et al. demonstrated that for hydrophobic surfaces, there is not necessarily a positive correlation between increased contact angle and slip length.

Fundamentally, the effective reduction of solid-liquid boundary as a superhydrophobic drag reduction mechanism should be independent of whether the flow is laminar or turbulent. In turbulent flows, a thin viscous-dominated sublayer exists very near to the wall. It extends to a height, measured in terms of wall units, viscous lengths, of y⁺=y/v\sqrt{τ_{w}/ρ}=5 where y is the height above the wall, v is the kinematic viscosity, τ_{w} is the wall shear stress and ρ is the fluid density. In the viscous sublayer, the mean velocity increases linearly with position, u⁺=y⁺. Changes in momentum transfer to the viscous sublayer can have a dramatic influence on the entire turbulent flow and can result in drag reduction. This effect is demonstrated in the direct numerical simulation (DNS) studies of Min and Kim who imposed a fixed, arbitrary, but not unreasonable, longitudinal slip length boundary condition in a turbulent channel flow. Similar work was performed by Fukagata et al. who related drag reduction and slip length. More recently, we used DNS to study the turbulent flows over periodic slip/no-slip boundary conditions to simulate microposts and microridges geometries that approximate the superhydrophobic surfaces presented here. Their simulations predict a drag reduction that increases with both the microfeature spacing and the surface coverage of the shear-free air-water interface as well as with the Reynolds number. In addition to the presence of the shear free interface, drag reduction mechanisms such as surface compliance and turbulent structure attenuation may also exist for micropatterned superhydrophobic surfaces.

Few experimental studies have considered superhydrophobic drag reduction into the turbulent regime. In a recent experimental study, Gogte et al. observed drag reduction in turbulent flow over a hydrofoil coated with a randomly structured superhydrophobic surface produced from hydrophobically-modified sandpaper. Drag reductions of up to 18%, based on combined skin friction and form drag, were reported for the hydrofoil. Overall drag reduction on the hydrofoil decreased with increasing Reynolds number. However, one should note that the total drag was reported and the individual contributions of friction and form drag were not deconvoluted. The form drag of the body should increase significantly with Reynolds number and could obscure the performance trend of the superhydrophobic surface which affects only skin friction drag. It is not necessarily inconsistent for skin friction drag reduction to be stable or increasing with Reynolds number as predicted by our DNS simulations. Balasubramanian et al. achieved similar results for flow over an ellipsoidal model with a disordered superhydrophobic surface similar to that employed by Gogte et al., but having smaller microfeatures. Henoch et al. demonstrated preliminary success in a conference proceeding noting drag reduction over 1.25 μm spaced “nanograss” posts in the turbulent regime.

Similar in physical mechanism to superhydrophobic drag reduction, air layer drag reduction, results from continuous air injection sufficient to produce an uninterrupted vapor layer existing between the solid surface and the water. Such air layers are an active technique for producing drag reduction; they do not require chemical hydrophobicity of the surface and exist only as long as the required air injection rate is maintained. Elbing et al. demonstrated air layers are capable of producing nearly complete elimination of skin friction drag. The authors demonstrated the existence of three distinct regions; bubble drag reduction at low air injection rates where performance is linear with air injection rate and drag reductions up to 20% can be achieved, a transitional region at moderate injection rates, and a full air layer at large air injection rates. Once the full air layer is achieved, Elbing reported little performance increase with additional airflow. It should be noted that drag reduction falls off with distance from the injection point until a complete air layer is achieved. Reed utilized millimeter sized ridges to capture and stabilize injected air and form a continuous air layer between the ridges. The author noted hydrophobic walls, with ridge features much too large (mm) to produce a superhydrophobic effect, exhibited an enhanced ability to form and maintain stable air layers. Additionally, Fukuda et al. demonstrated an increase in drag reduction obtained when a discontinuous layer of injected bubbles are attracted by walls treated with hydrophobic paint.

Geometrically, riblets appear similar to the superhydrophobic surfaces under present consideration; however, their scale and function are completely different. Riblets are ridges aligned in the flow direction which reduce drag in turbulent flows by disrupting the transverse motion of the fluid at the surface, thereby moving near-wall turbulent structures farther from the wall. Unlike superhydrophobic surfaces, the grooves between riblet features are wetted by the fluid, and function equally well for both liquids and gasses. Unfortunately, riblet geometries only perform well within a limited range of Reynolds numbers and can have derogatory effects outside of their designed range. To function, riblets must maintain a spacing, w⁺=w/v\sqrt{τ_{w}/ρ}, between 10<w⁺<30 wall units. The superhydrophobic microfeatures we have used are at least an order of magnitude too small to produce a riblet effect. It is believed that the observed drag reduction is due to the presence of a shear free air-water interface supported between microfeatures.

We describe particle image velocimetry (PIV) and pressure drop measurements of a turbulent channel flow over several superhydrophobic walls. The superhydrophobic surfaces were engineered with regular arrays of microridges aligned in the flow direction in order to systematically investigate the effect of topological changes on the velocity profiles, slip length and drag reduction in turbulent channel flows. Superhydrophobic PDMS test surfaces were cast from silicon wafer molds produced by a lithographic process. A 25 μm layer of SU 8 photoresist (Microchem) was spun onto bare or oxide coated silicon wafers. The substrate was then exposed through a negative mask of the desired pattern and developed to produce a mold. A micrograph of a typical wafer mold, in this case for 60 μm microridges spaced 60 μm apart, is shown in FIG. 1B. Once completed, the wafers were used to cast patches of micropatterned PDMS approximately 150 mm long which were then seamlessly joined to produce a 1 m long superhydrophobic surface. All measurements are conducted on the downstream section of the patch, minimally thirty channel half heights, δ, downstream of the nearest patch joint. Smooth test surfaces were prepared by curing PDMS on a smooth flat cast PMMA plate. The PDMS was treated with a highly fluorinated silane (Gelest, Tullytown, Pa.) to make it more hydrophobic, resulting in an advancing contact angle of approximately θ=125°. Untreated PDMS having an advancing contact angle of approximately θ=110° on a smooth surface was also used with identical results. No measurable slip lengths were observed for flows over smooth PDMS surfaces. It should be noted that for materials not demonstrating slip over smooth surfaces, contact angle is important to superhydrophobicity only inasmuch as it increases the maximum pressure sustainable by the three phase interface. Contact angle does not affect the shear free area or the interface deflection for a fixed sustainable pressure, and thus should not affect the turbulent drag reduction obtained. A section of microridge superhydrophobic surface is seen in FIG. 4. FIG. 4 is an illustration of water (two droplets) and ethanol (one droplet) resting on a superhydrophobic surface. The water drops stand off the surface in the Cassie state while ethanol fully wets the surface in the Wenzel state. Microridges run front to back and the air-water interfaces they support are visible under the water drops.

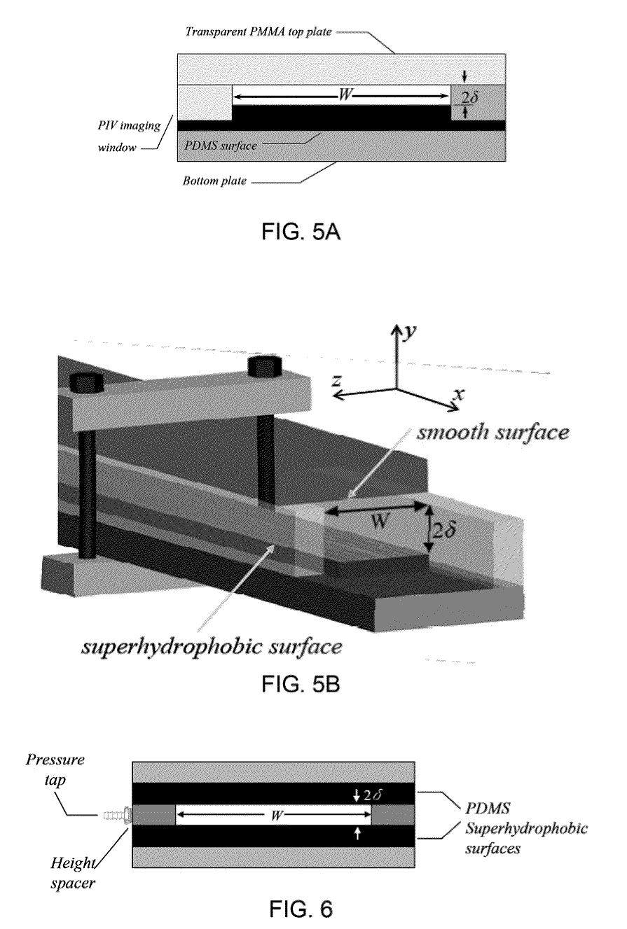

PIV is conducted in a rectangular channel flow geometry shown in FIG. 5A and FIG. 5B, fabricated from optically clear polymethyl methacrylate (PMMA) with a single interchangeable polydimethylsiloxane (PDMS) test surface at the bottom wall. The channel was W=38.1 mm wide and full channel height was 2δ=7.9 mm. Reverse osmosis purified water was used as the working fluid. Water purity does not seem to affect drag reduction results the same water was used for several weeks with no change in performance. For PIV, the water was seeded with 0.005 wt % of 11 μm diameter hollow silvered glass spheres (Sphericel, Potters Industries, Carlstadt, N.J.). Flow was provided under gravity from a head tank and collected for reuse. A centrifugal pump returns fluid to maintain head level, provisions exist to run the apparatus directly from the pump although, to reduce vibrations, the pump is turned off during measurements. Static pressures within the flowcell were held below 5 kPa to ensure the Cassie state was maintained. Ridges were designed to prevent air from escaping at the ends to allow operation near or possibly slightly above the limit predicted by Young's law for captive air at atmospheric pressure. The flow rate was measured by one of two turbine flow meters (low flow rates FTB-603, Omega; high flow rates FTB-902, Omega) placed in series with the test section. It was adjusted by a throttling valve located far upstream. Reynolds number was calculated from flow rate and verified by numerical integration of velocity profiles when PIV profiles of the entire channel height were accessible. PIV was conducted in the x-y plane at mid channel approximately 200-225 half heights from the inlet, far enough downstream to ensure a fully developed turbulent flow over the superhydrophobic surfaces. Illumination is provided by a 500 μm wide light sheet. Images were recorded with a high-speed video camera (Phantom 4.2) at frame rates up to 8500 frame per second and correlated with a commercial code (DaVis, LaVision Gmbh). Under the maximum magnification of our experiments, the velocities could be accurately resolved within 50 μm from the wall. At reduced magnifications, PIV images cover the entire channel to simultaneously observe smooth top and superhydrophobic bottom walls. Images were recorded under ambient lighting to establish wall location; for full channel measurements the true wall location is known to within 10 μm accuracy. Up to 10,000 frames of steady state flow were captured, correlated and averaged to generate each velocity profile. Scale was established by imaging targets and verified with the known height of the channel.

We consider two superhydrophobic microridge geometries and the smooth PMMA top wall, which have been tested over a range of mean Reynolds numbers 2000<Re=2δU/v<9500. Here U is the mean fluid velocity measured from the flow. Transitional effects are considered to persist up to Re=3000 for this flow. Two geometries with 50% shear-free air-water interface coverage were considered. The first contains microridges d=30 μm wide and spaced w=30 μm apart (30-30) and the second contained microridges d=60 μm wide and spaced w=60 μm apart (60-60). As noted, feature sizes considered range from w⁺<2 wall units for the 30-30 ridges and remain less than w⁺<3.5 wall units for the 60-60 ridges. These ridge spacings are an order of magnitude too small to produce a riblet effect over the present range of Reynolds numbers.

Additional quantification of superhydrophobic drag reduction was obtained through direct pressure drop measurements in the channel. Here, the test section was replaced with a channel having superhydrophobic surfaces on both top and bottom walls, as shown in FIG. 6. The channel height was set by the precisely machined aluminum side spacer seen in the figure, and the flowcell assembly was conducted with a calibrated wrench to maintain precise uniformity of the channel between tests, fixing the channel aspect ratio. The channel was W=38.1 mm wide and 2δ=5.5 mm high. Additionally, multiple data collection sessions were performed for each surface, with reassembly of the apparatus between each session. Measurements were conducted from single taps, as illustrated, over a 70 mm span more than 130δ from the channel inlet. Pressure was read directly from a pair of water column manometers reading static pressures at the front and back of the test section. Water column heights were photographically recorded, the differences in column height being used to calculate the pressure drop across the test section. The manometer resolution was ±1 Pa, which resulted in pressure drop measurement uncertainty that ranged from 5% for the slowest flows to 0.5% for the highest Reynolds numbers tested. Flow rate was measured with a turbine flow meter as in the PIV experiments. Flow control and Reynolds number capabilities are identical to those used for PIV. To ensure steady state, data points were taken no more than once per minute and the flow rate was adjusted only incrementally between measurements. Data was collected on increasing and decreasing flow rate sweeps to ensure that no hysteresis was observed.

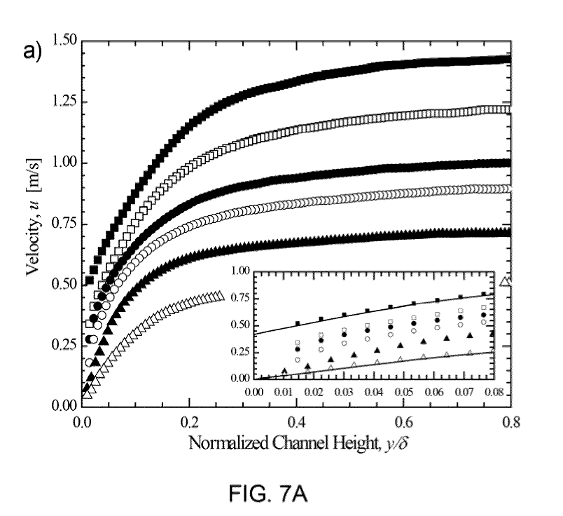

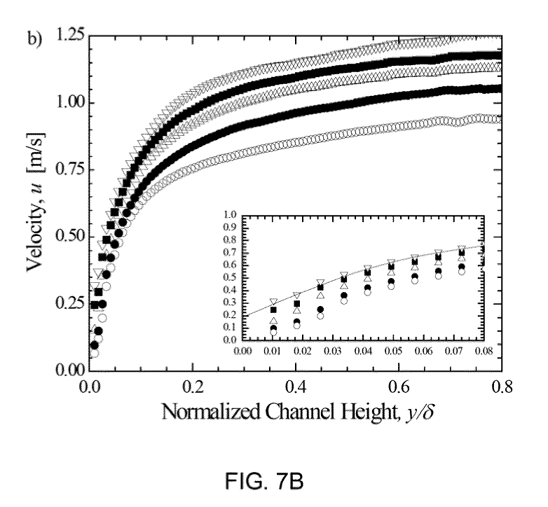

A typical set of velocity profiles, resulting from PIV near the superhydrophobic wall for the 60-60 ridge surface is shown in FIG. 7A for a range of Reynolds number between 2700<Re<8200. The effect of the superhydrophobic wall is not observed for the low Reynolds number experiments. At the low Reynolds numbers, the turbulent velocity profiles just past transition are, to the limit of our measurements, equivalent to smooth profiles at identical Reynolds numbers This is not unexpected for the data points in the laminar or transitional regime. In laminar flows, superhydrophobic surfaces of similar size and geometry demonstrated slip lengths which were independent of flow rate and approximately b=25 μm. For pressure driven flow between two infinite parallel plates separated by a distance 2δ the volume flow rate per unit depth is given by

$$q = \frac{2 {δ}^{3}}{μ} ( - \frac{d p}{d x} ) [ \frac{1}{3} + \frac{b}{b + 2 δ} ] . \qquad Eqn . ( 3 )$$

For a given pressure gradient, dp/dx, and fluid viscosity, μ, the volume flow rate can be significantly enhanced only if the slip length is comparable to the channel height. Previous laminar regime studies over similar superhydrophobic microfeatures measured slip lengths of b=25 μm independent of Reynolds number. In our channel geometry, such laminar flow slip lengths would produce a drag reduction of around 1%. Additionally, for small slip lengths, the expected slip velocity can be approximated by uₛₗᵢₚ=4Ub/δ which should also be on the order of only a couple of percent of the average free stream velocity, U, and below the resolution of our PIV measurements. As the Reynolds number is increased and the flow becomes fully turbulent, however, a substantial slip velocity, and slip lengths greater than b=25 μm, are observed along the superhydrophobic wall. The presence of an air water interface is visually apparent on the superhydrophobic surface giving it a silvery appearance. This result, due to the differing indices of refraction and slight curvature of the interface, was observed throughout the range of testing giving us confidence that the interface was maintained for all of the results reported here.

As the inset of FIG. 7A clearly shows, the magnitude of the slip velocity was found to increase with increasing Reynolds number. Similar, although less pronounced, trends were observed for the 30-30 ridge case as seen in FIG. 7B. Significant deviation from no-slip behavior is noted past a Reynolds number of approximately Re=4000 for both the 30-30 and 60-60 ridged cases. Above these Reynolds numbers, a nearly linear increase in the slip velocity with increasing Reynolds number was observed for each of the superhydrophobic surfaces used. A maximum slip velocity of nearly 40% the mean channel velocity, uₛₗᵢₚ/U=0.4 was observed for the 60-60 ridged case at the highest Reynolds numbers tested.

In order to determine both the shear stress and slip velocity at the smooth and superhydrophobic walls, the PIV velocity fields were fit to a modified Spalding equation for turbulent velocity profile above a flat plate,

$${y}^{+} = ( {u}^{+} - {u}_{slip}^{+} ) + {e}^{- 2.05} [ {e}^{- 0.41 ( {u}^{+} - {u}_{slip}^{+} )} - 1 - 0.41 ( {u}^{+} - {u}_{slip}^{+} ) - \frac{1}{2} {( 0.41 ( {u}^{+} - {u}_{slip}^{+} ) )}^{2} - \frac{1}{6} {( 0.41 ( {u}^{+} - {u}_{slip}^{+} ) )}^{3} ] . \qquad Eqn . ( 4 )$$

The Spalding equation is an empirical fit to experimental turbulent velocity profile data that covers the entire wall region through the log layer. This allows the fit to be applied farther into the channel, to determine the wall shear stress more accurately using a greater number of data points than would be available within the viscous sublayer. Wall shear stress enters the equation in the definition of the velocity, u⁺, and position y⁺, in wall units. To account for slip, each instance of the velocity in wall units, u⁺=u\sqrt{ρ/τ_{w}}, in the Spalding equation was replaced by the difference u⁺−uₛₗᵢₚ⁺. The fit was performed by a numerical routine given an initial value for slip velocity extrapolated from a coarse linear fit of near wall data points. An initial wall shear stress was determined by minimizing the error in the fit. Subsequent iterations were performed on wall slip velocity and wall shear stress to minimize the standard error of the fit over the interval 0<y⁺<50. The resulting fits were accurate to better than 4% at a 95% confidence interval. The results were not appreciably different if the fit is taken to y⁺=100. The size of the PIV correlation window was chosen to be 0.2 mm. For the frame rates used, the resulting particle displacements within the correlation window were typically much less than 25% of the window in the viscous sublayer and less than 33% of the window everywhere for Reynolds numbers less than Re<4500. Large particle displacements were observed far from the wall at the highest Reynolds numbers, however, no noticeable effects were observed on the resulting profiles.

As seen in FIG. 7A and FIG. 7B, the resulting fits of Equation 3 to the velocity profiles are excellent with and without slip, which instills confidence in the values of shear stress calculated from the velocity gradient extrapolated to the wall, ρ_{w}=μ(∂u/∂y)|ᵥ₌₀. The maximum slip velocity and observed wall shear stress reductions correspond to slip lengths of b>70 μm for the 30-30 microridges and b>120 μm for the 60-60 microridges. Larger slip velocities and slip lengths were measured for turbulent flow past superhydrophobic surfaces with larger microfeature spacings even as the percentage of shear-free interface was kept constant at w/(w+d)=0.5, as has been observed in the laminar flow measurements over superhydrophobic surfaces. This observation is consistent previous laminar flow studies and with the predictions of DNS in turbulent flows. Additionally, Ybert et al. showed through a scaling argument that in laminar flows one expects the slip length to scale linearly with the microfeature spacing, b∝(w+d).

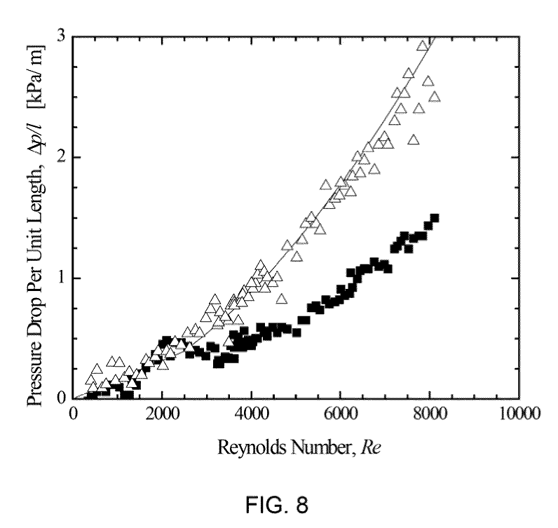

In FIG. 8, direct measurements of the pressure drop per unit length of channel, dp/l, are shown for a smooth PDMS surface and the superhydrophobic surface containing 60 μm ridges spaced 60 μm apart in an identical channel. The result predicted by the Colebrook equation for a perfectly smooth channel of the same dimension is plotted for reference. The pressure drop per unit length is directly related to the channel geometry and the wall shear stress, dp/l=τ_{w} (1+2δ/W)/δ, so it provides a second method for measuring drag reduction. Significant drag reduction is initially noted by a leveling off of the in the pressure drop during the transition from laminar to turbulent flow between Reynolds numbers of 2000<Re<3000. These data indicate a delay in the transition to fully-developed turbulent flow. Additionally, for Reynolds numbers greater than Re>3000 the pressure drop over the surperhydrophobic surface grows at roughly half of the rate of pressure drop over the smooth surface. The Colebrook line, accurately fits the turbulent flow data from the smooth surface, and the predicted laminar flow result passes through the microridge data in the laminar region below Re<2200. This result is consistent with those predicted by Equation 2 and observed by PIV. As noted before there is no measurable drag reduction or slip velocity for the present channel geometry in the laminar regime.

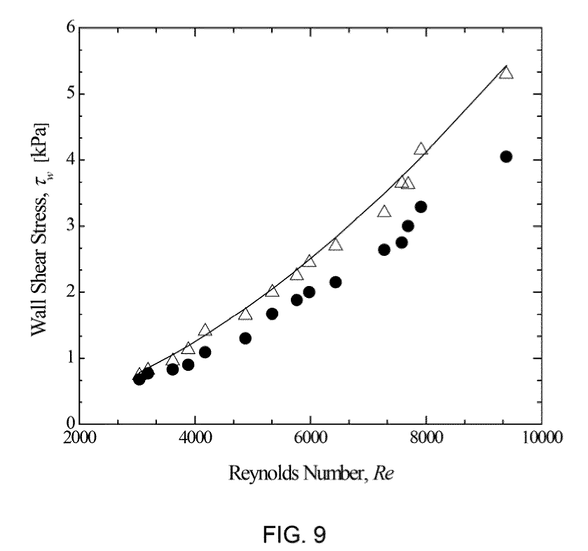

Further insight comes from the full channel PIV where smooth and superhydrophobic surfaces may be simultaneously observed at the same mean channel Reynolds numbers. Wall shear stress, calculated from the modified Spalding fits, is shown in FIG. 9 for the smooth and superhydrophobic surfaces. Again the Colebrook line for a channel of the same dimensions is shown for comparison. Shear stress reduction on the superhydrophobic wall follows the same trends observed from pressure measurements in FIG. 8. Little significant drag reduction is observed Re<3000 with a marked reduction in rate of shear stress increase for Re>5000. The smooth wall behaves as expected for an entirely smooth channel, as indicated by the good agreement with the Colebrook line.

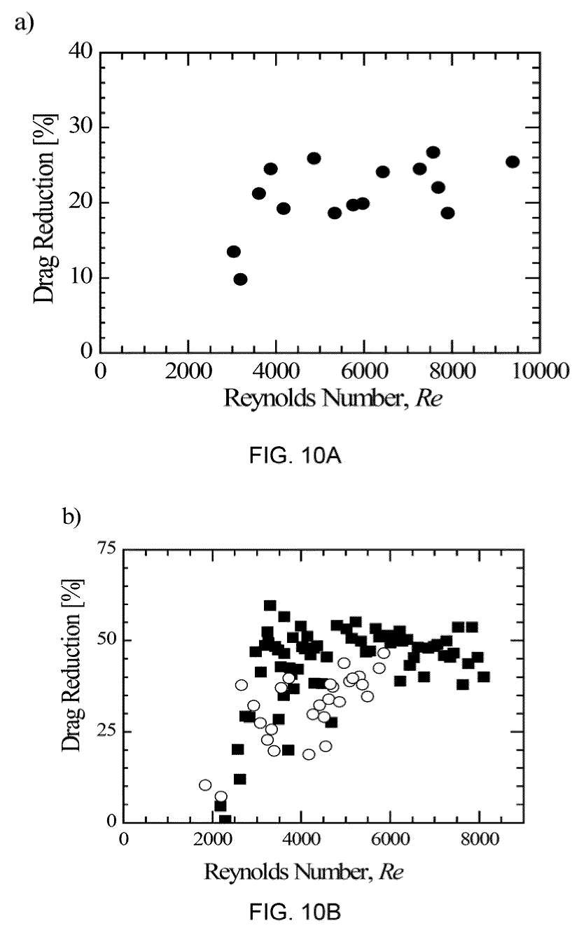

The turbulent drag reduction, D_{R}=(τₙₒ₋ₛₗᵢₚ−τ_{SH})/τₙₒ₋ₛₗᵢₚ, was computed as the percent difference in shear stress at the superhydrophobic and no-slip wall and is presented in FIG. 10 as a function of Reynolds number. Drag reduction is presented rather than slip length because the slip length is difficult to quantify from the pressure drop measurements in turbulent flows. The slip length calculated from PIV data is insignificant in the laminar region and obtains a maximum value greater than b=70 μm for 30-30 and greater than b=120 μm for 60-60 ridges. In the present experiments, a maximum drag reduction of approximately 50% was observed for both microridge geometries once a suitably high Reynolds number was achieved. Drag reduction is initiated at a critical Reynolds number in the turbulent regime. For the microridges under present consideration, the critical Reynolds number was determined to be Re_{crit}≈2500. This Reynolds number is at or just past the transition to turbulent flow. This observation, along with the noted lack of drag reduction in the laminar regime, suggest that the underlying physical cause of the observed turbulent drag reduction must relate to the unique structure of wall-bounded turbulent flow.

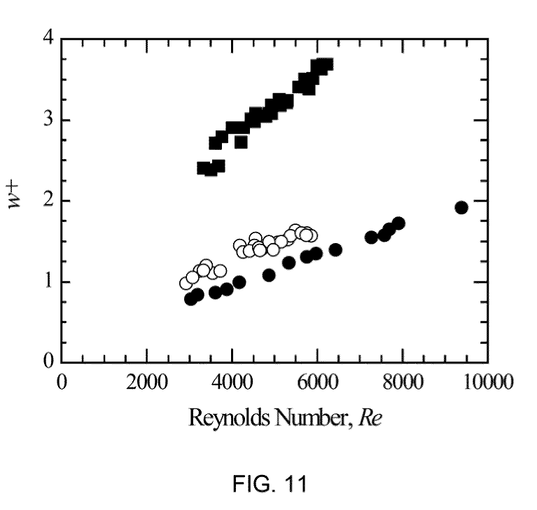

The physical origins of the critical Reynolds number for the onset of drag reduction can be understood by analyzing the relevant lengthscales in the flow. If the drag reduction and the slip length were dependent on the microridge geometry and channel dimensions alone, as is the case in laminar flows, then we would expect to find the drag reduction and slip length to be independent of Reynolds number. In turbulent flows, however, there is a third lengthscale of importance, the thickness of the viscous sublayer which extends out to y⁺=5. Although the viscous sublayer thickness remains fixed in wall units, in dimensional form the thickness of the viscous sublayer decreases with increasing Reynolds number as yᵥₛₗ=5v\sqrt{ρ/τ_{w}}. Close to the wall, where viscous stresses dominate, the analytical solutions of Philip show that the influence of the shear-free air-water interface extends to a distance roughly equal to the microridge spacing, w, into the flow. Thus for the superhydrophobic surface to impact the turbulent flow, the microridge spacing must approach the thickness of the viscous sublayer, w≈yᵥₛₗ, or in other words w⁺=y⁺≈5. As seen in FIG. 11, the microfeature spacing in wall units is at least w⁺>0.75 for all the 30-30 surfaces tested and w⁺>2.4 for the 60-60 surfaces. The w⁺ values are calculated from shear stress measured at the superhydrophobic surface. This means that the microfeature spacing is minimally 15% to 50% of viscous sublayer thickness almost immediately after the turbulent transition. Hence for 30-30 and 60-60 ridges, drag reduction is noticed almost as soon as a turbulent flow develops. In laminar flows, significant drag reduction is noted at feature to height ratios comparable to those seen with the present feature size and viscous sublayer thickness. A similar scaling has been observed for turbulent flow over wetted, rough surfaces, where the effects of roughness are not observed until the size of the roughness exceeds the thickness of the viscous sublayer. As the Reynolds number increases and the thickness of the viscous sublayer is further reduced, the presence of the superhydrophobic surface will more strongly influence the velocity profile within the viscous sublayer and reduce the momentum transferred from the fluid to the wall and the vorticity of the fluid at the edge of the viscous sublayer. Turbulence intensity is thereby reduced, increasing the drag reduction. One therefore expects that saturation of the turbulent drag reduction is likely in the limit of very large Reynolds numbers where the microridges are much larger than the viscous sublayer. In this limit, the drag reduction should approach a limit of D_{R}=w/(d+w) as momentum is only transferred from the solid fraction of the superhydrophobic surface and the viscous sublayer is thin enough that the no-slip and shear-free portions of the surface can be considered independently. For the present shear free area ratios, this limit would be 50%. This is consistent with both the asymptotic value of our PIV and pressure drop measurements. Drag reduction results shown in FIG. 10 appear consistent with this hypothesis, the 60-60 ridges already appearing to plateau. As the critical Reynolds number will decrease with increasing feature spacing, coarser superhydrophobic surfaces will begin to perform better at lower Reynolds numbers. It is therefore expected that equivalent drag reduction performance will be accessible to much finer microfeature spacings at higher Reynolds numbers. With fine superhydrophobic surfaces, little drag reduction may be evident until the viscous sublayer shrinks significantly, well past transition. This result appears promising for possible commercial applications of this technology. This is because small feature spacing results in a more robust superhydrophobic surface capable of maintaining a coherent air-water interface at larger static pressures, while at the same time ships that might benefit from such surfaces operate at Reynolds numbers significantly greater than those interrogated in the present experiments.

Significant drag reduction has been measured by PIV and direct pressure measurements in turbulent flows over superhydrophobic microridge surfaces. No significant drag reduction or slip velocities were noted in the laminar regime, consistent with theoretical predictions of laminar flow superhydrophobic drag reduction and previous experimental studies. This and the slip velocities observed at the wall demonstrate that the drag reduction is due to the presence of a shear-free interface. Slip velocities and drag reductions were found to increase with Reynolds number, the latter appearing to plateau at the highest Reynolds numbers tested. This drag reduction is found to increase more quickly with increasing feature spacing for equal shear free area ratio. Our results indicate that viscous sublayer thickness is the correct height scaling for these surfaces and there exists a critical Reynolds number reached as the viscous sublayer thickness approaches microfeature size, when the onset of drag reduction will occur.

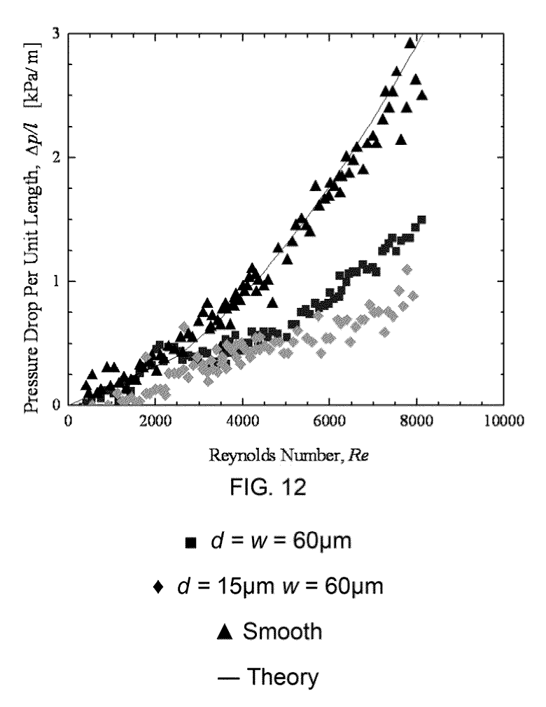

FIG. 12 is a diagram showing pressure drop per unit length vs. Reynolds number for various structures, which are compared to theory. FIG. 12 shows very good agreement with theory for smooth surfaces. As expected, there is no measurable drag reduction in the laminar regime. Drag reduction initiates when the Reynolds number reaches the expected turbulent transition. The observed pressure drop demonstrates a dependence on the geometry of the superhydrophobic surfaces.

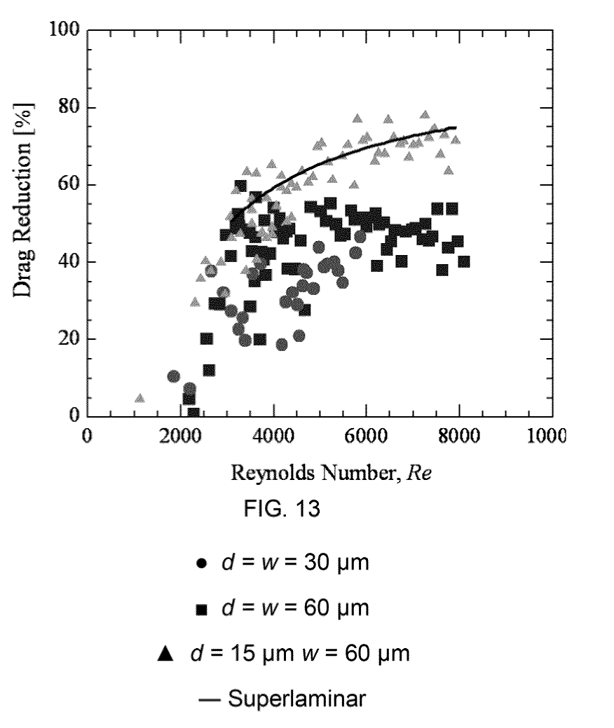

FIG. 13 is a diagram showing drag reduction vs. Reynolds number for various structures, which are compared to superlaminar flow (theory). FIG. 13 illustrates that drag reduction increases with Reynolds number, and plateaus to nearly the shear free area ratio. As shown in FIG. 13, surfaces having d=15 μm and w=60 μm follow the super-laminar curve, at least at low to moderate Re. surfaces having larger feature spacings plateau earlier. This indicates that drag reduction and the relevant length scale are velocity dependent.

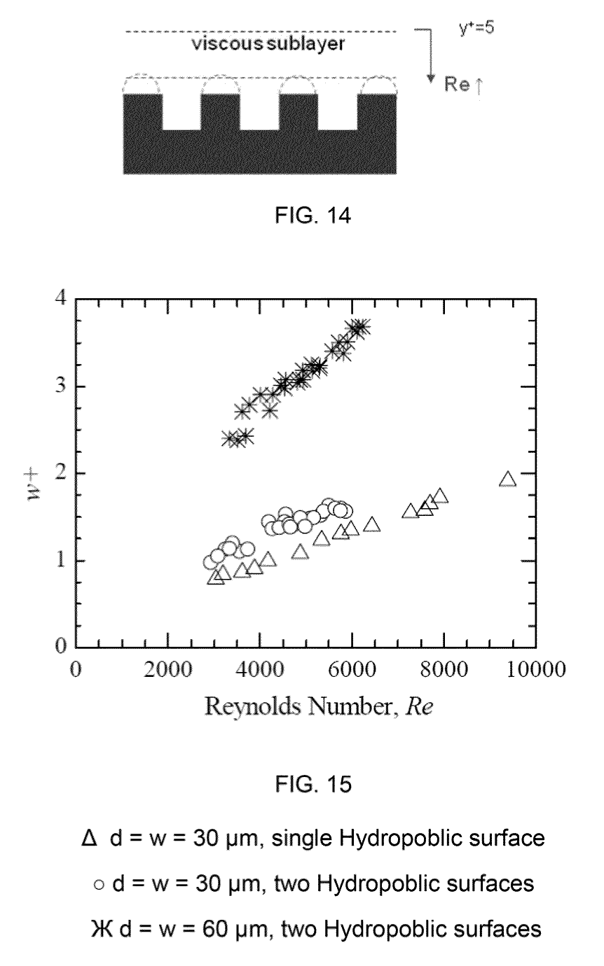

FIG. 14 is a diagram of the relationship of a viscous sublayer to a surface according to principles of the invention, as a function of Reynolds number. Momentum is transferred to the wall through the viscous sublayer for y⁺<5. It appears that small changes greatly effect the entire flow. The thickness decreases (as indicated by the arrow pointing down) with increasing Reynolds number (as indicated by the arrow pointing up). Drag reduction is observed to exist when the viscous sublayer approaches microfeature size. At high Reynolds number, the viscous sublayer is thin enough that the solid/liquid interface affects only the flow directly above it.

FIG. 15 is a diagram of the relationship between wall units, w⁺, as a function of Reynolds number, for different structures having d=w=30 μm and d=w=60 μm.

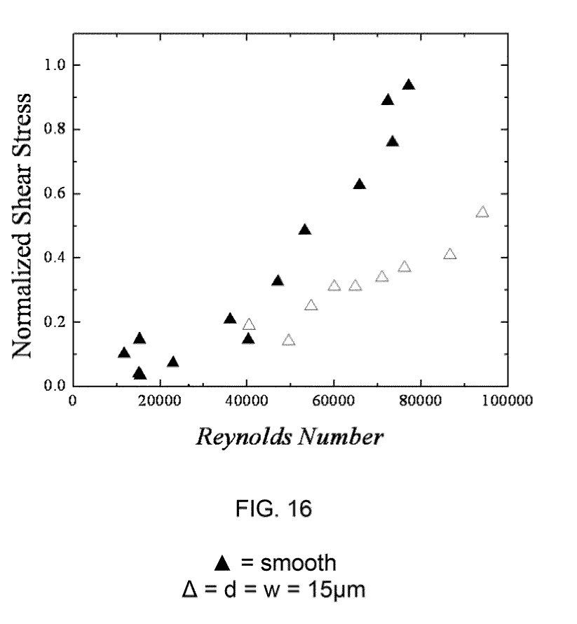

FIG. 16 is a diagram of the relationship between normalized shear stress as a function of Reynolds number, for different structures having d=w=15 μm and a smooth structure. FIG. 16 shows data from shear balance apparatus between 10 000<Re<100 000, which are higher velocities and Reynolds numbers as compared to FIG. 12, FIG. 13 and FIG. 15. The data in FIG. 16 indicates that the surfaces and the drag reduction are robust at higher shear stresses and velocities. The data was observed for a larger channel (H=13 mm), higher speeds (U>7.5 m/s) and smaller features. The drag reduction performance is comparable to that at low Reynolds number at similar shear free area ratios.

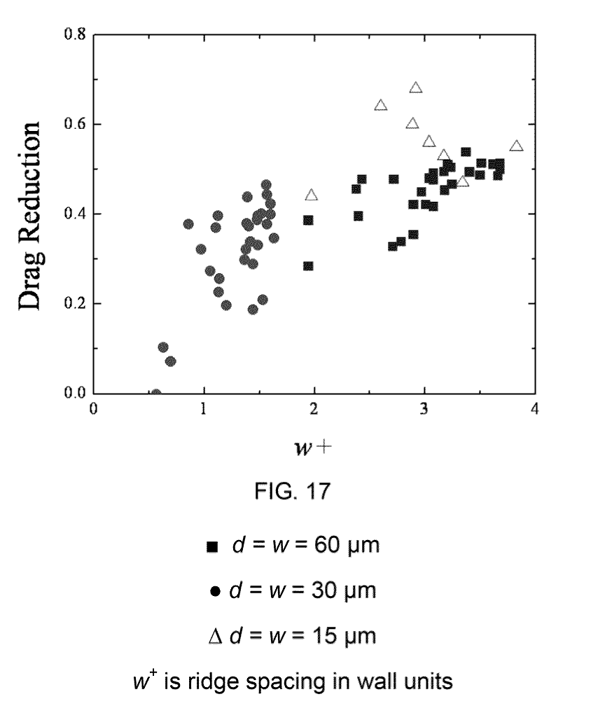

FIG. 17 is a diagram showing drag reduction vs. wall units, w⁺, for various structures having d=w=15 μm, d=w=30 μm and d=w=60 μm. As illustrated in FIG. 17, the results collapse to a single curve for a given shear free area ratio. It appears that Re, and w⁺ describe these surfaces better than Re and physical size.

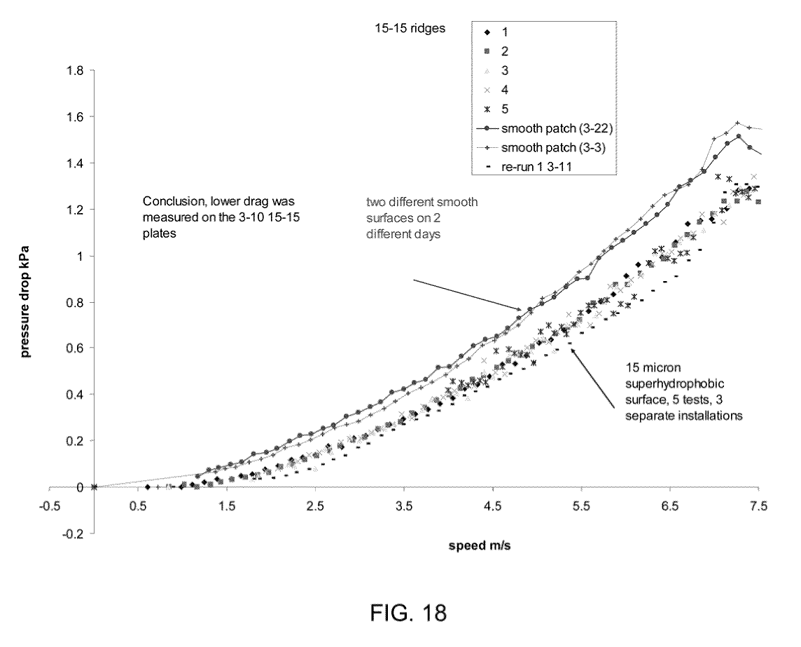

FIG. 18 is a diagram showing the drag reduction for repeated measurements of a surface having d=w=15 μm as compared to a smooth surface. In FIG. 18, repeated measurements of a surface having d=w=15 μm (2 mm long ridges with “breaker ridge,” capped ends) are compared to a smooth surface. For the results shown, approximately ⅓ of the test section is coated in superhydrophobic surface. The channel design was necessary to accurately log data at the higher flowrates. Drag reduction values in this single wall case are consistent with the two wall cases studied previously.

Numerous surface geometry configurations (size, spacing etc) have been tested. A flow speed of up to 7½ m/s approaches the velocity of typical marine vessels. Results demonstrate smaller microfeatures perform best in high Reynolds number experiments, a behavior consistent with previous expectations.

Superhydrophobic Surfaces to Alter Vortex Shedding from Structures

The study of the flow past a circular cylinder perpendicular to the flow direction has a long history starting from the initial studies of Benard and the stability analysis of von Kármán. An number of excellent reviews of the literature exist, including the most recent by Williamson. A number of different flow regimes exist and the transition to each have been quantified for no-slip cylinders. Below a Re<49, the wake behind the cylinder is comprised by two steady, counter-rotating vortices. Above Re>49 the wake becomes unstable and a laminar vortex shedding regime persists up to a Re>200. In this regime, the dimensionless shedding frequency, the Strouhal number, St=fD/U, decreases with increasing Reynolds number in a known way, St=0.212(1−21.21 Re). The flow moves through transition until a Reynolds number of Re>1000 when the wake becomes fully turbulent, the separation moves upstream along the cylinder and the Strouhal number continues to decrease, although more slowly, with Reynolds number. Tracking the changes to the Strouhal number scaling with Reynolds number is an excellent starting point for quantifying the effect of slip on the cylinder surface.

The expectation is that superhydrophobic surfaces will decrease both drag, lift and vibrations on a submerged cylinder or other blunt or hydrodynamic bodies in flow, at least at high Reynolds numbers where the viscous sublayer is comparable to the spacing between microfeatures. Additionally, we expect that the transitions in vortex dynamics will be shifted to larger Reynolds numbers due to the slip on the superhydrophobic surface and the reduction of momentum transferred from the flow to the cylinder through the shear layer around the cylinder. The reduction in vortex shedding intensity and frequency can have a significant effect on stresses and fatigue on objects such as underwater cables where vortex induced vibrations are a major cause of failure and can significantly reduce the lifetime of cables.

There is a large patent and publication record involving modifications to cylinders and other submersible objects to minimize vortex induced vibrations. We have found no prior art using superhydrophobic surfaces in this subject matter area. We believe that the presence of an air-water interface (or more generally, a gas-water interface) will have a large impact on the location of shear layer separation, the evolution of the shedding vortices with Reynolds number and the intensity of the vortex induced vibrations.

The addition of drag reduction agents like polymers, or surfactants, to the flow can have a profound effect on the vortex dynamics. The presence of the drag reducing surfactant completely alters the flow in the wake of the cylinder at high Reynolds numbers. The shear layer detaches much later and the counter-rotating vortices observed in the water case are completely eliminated. The expectation is that superhydrophobic surfaces will have a similar impact on separation.

We contemplate the use of superhydrophobic surfaces (with or without our breaker ridge geometry) to alter vortex shedding on structures submerged in a liquid. We contemplate the use of superhydrophobic surfaces to alter vortex shedding for the purpose of reducing vibrations and or stress/fatigue on structures submerged in a liquid. We contemplate the use of superhydrophobic surfaces to control, select or selectively attenuate or enhance specific frequencies of vortex shedding over an object submerged in a liquid. Since vortices are shed off structures of non-circular cross section as well as circular cross sections (such as the pedagogical case described in the background), we contemplate the use of such systems and methods with structures that are not necessarily circular or cylindrical.

### Methods of Fabricating Surfaces Described in the Application

We have produced superhydrophobic surfaces using sacrificial particles such as salts, although polymers, such as polyethylene oxide, would be preferable, to form the microstructure of the surface once the particles are dissolved out. With certain polymers, salts or other water soluble materials, a superhydrophobic hull coating could be sprayed, brushed or spread and the particles dissolved out by the seawater as the ship or coated object is in service.

Using particles of the proper size and shape (corresponding to the width and length of the depressions in the breaker ridge superhydrophobic surface geometries previously disclosed) these particles could be oriented by shear in the fluid carrying them, which would produce superhydrophobic surfaces with the structure described previously when the particles are removed. Particles are expected to align with their major axes in the direction that the fluid is being sheared, normal to the shear gradient. After dissolving out the particles, each rod or rectangular particle leaves a depression with capped ends, a multitude of such particles creating the capped breaker ridge patterns functionally like those previously disclosed. Deposition and orientation could be performed during the process of applying the base coating (by brushing, squeeging, withdrawing from a vat, spin coating, etc) if the particles are suspended in the liquid base coating material, or by laying down oriented particles on uncured base previously applied to the surface (air or other fluid to carry/orient the particles).

These processes could greatly increase manufacturability of these surfaces and could have applications beyond underwater coatings. In some embodiments, the surfaces so produced are expected to provide oriented superhydrophobic surfaces for self-cleaning applications on buildings, automobiles, wind turbines and other applications.

Our laboratory tests of our superhydrophobic surfaces have demonstrated significant drag reduction on flat plates, hydrofoils and cylinders for flow speeds up to 10 m/s. These speeds are at or above the typical operating speeds of most ships including tankers, barges, container ships, fishing vessels, cruise boats, ferries, warships, kayaks, canoes, rowing shells as well as most pleasure craft, yachts and sailboats. Additionally, we expect that these superhydrophobic surface will continue to produce significant drag reduction at speeds up to and in excess of 50 m/s where speedboats, racing sailboats, catamarans and cigarette boats operate.

It is expected that such superhydrophobic surfaces will permit one to alter the vortex shedding properties of structures submerged in a fluid. It is expected that one will be able to alter vortex shedding for the purpose of reducing vibrations and or stress/fatigue on structures submerged in a fluid. It is expected that one will be able to control, select or selectively attenuate or enhance specific frequencies of vortex shedding over an object submerged in a liquid.

Systems and methods of the invention are expected to be useful in stationary structures, such as aqueducts, pipes, piers, docks, pilings, bridge piers, buoys and markers, underwater cables, tethers and hoses, canals and open channels, run-off surfaces such as road gutters or drains, and interior surfaces of structures that carry fluids such as plastic tubing, pipes and water tanks. Systems and methods of the invention are expected to be useful in machinery that operates with fluids, such as turbomachinery, turbobachenery with air-cooled blades, turbines and waterwheels and washing machines.

Systems and methods of the invention are expected to be useful in vessels and other objects that move through or in contact with fluids, such as torpedoes, depth charges, submarines, autonomous submersibles, autonomous boats and surface vessels, diving equipment, wetsuits, seaplane/flyingboat hulls and pontoons, rafts and non-rigid watercraft, swimsuits, towed arrays (submarines and surface ships), canoes, kayaks, rowing shells, oars, rudders and keels, hydrofoils, hovercraft, air-boats, surf boards, waterskis, windsurfing equipment, catamarans and multi-hull vessels, hydroplanes and amphibious motor vehicles. Systems and methods of the invention are expected to be useful in apparatus used in association with a fluid, such as fishing lures, aqualungs and semi-permeable membranes, aquarium tanks, fishing nets and lines, and windshield wiper blades.

We contemplate the preparation of superhydrobic surfaces (with or without breaker ridges) with microstructure fabricated from water soluble sacrificial microparticles suspended in the hydrophobic base material. We contemplate the preparation of superhydrobic surfaces (with or without breaker ridges) with microstructure fabricated from water soluble sacrificial microparticles applied (as by spraying etc) onto an uncured hydrophobic base material which was itself applied to the substrate in a previous step. Air or other fluid carries and orients the particles. We contemplate the fabrication of superhydrophobic surface microfeatures by orienting shaped sacrificial microparticles (water soluble or not, either suspended in the hydrophobic base or subsequent application onto an uncured base) using fluid flow, shear or spraying. (such as orienting by brushing, spreading/squeeging, and flowing on). We contemplate the use of these techniques to produce the breaker ridge geometry previously disclosed on hulls or underwater structures to reduce drag or affect vortex shedding. We contemplate the use of these techniques to produce superhydrophobic surfaces for self cleaning and non-maritime applications.

### Theoretical Discussion

Although the theoretical description given herein is thought to be correct, the operation of the devices described and claimed herein does not depend upon the accuracy or validity of the theoretical description. That is, later theoretical developments that may explain the observed results on a basis different from the theory presented herein will not detract from the inventions described herein.

Any patent, patent application, or publication identified in the specification is hereby incorporated by reference herein in its entirety. Any material, or portion thereof, that is said to be incorporated by reference herein, but which conflicts with existing definitions, statements, or other disclosure material explicitly set forth herein is only incorporated to the extent that no conflict arises between that incorporated material and the present disclosure material. In the event of a conflict, the conflict is to be resolved in favor of the present disclosure as the preferred disclosure.

While the present invention has been particularly shown and described with reference to the preferred mode as illustrated in the drawing, it will be understood by one skilled in the art that various changes in detail may be affected therein without departing from the spirit and scope of the invention as defined by the claims.

What is claimed is:

1. An engineered structure configured to provide reduced drag force experienced by a solid object and a fluid having relative motion therebetween, comprising:
a surface of said solid object;
a plurality of parallel ridges extending from said surface of said solid object, said plurality of parallel ridges each having a width d and a height h, said plurality of parallel ridges being spaced apart by a first spacing dimension w, said plurality of parallel ridges extending along said surface of said solid object for a predefined length l; and
at least two breaker ridges situated between at least two of said plurality of parallel ridges, said at least two breaker ridges being oriented at an angle to said length of said at least two parallel ridges, said at least two breaker ridges being situated apart from each other by a second spacing dimension, said at least two breaker ridges and said plurality of parallel ridges configured to define a volume wherein a gas may be situated;
whereby said engineered structure is configured to provide a reduced drag force between said fluid and said solid object having said engineered structure when said fluid and said solid object are in a relative flow relationship as compared to a drag force that would be generated between said fluid and said solid object lacking the engineered structure when said fluid and said solid object are in a relative flow relationship.

2. The engineered structure according to claim 1, wherein said fluid is water.

3. The engineered structure according to claim 1, wherein said fluid is sea water.

4. The engineered structure according to claim 1, wherein said fluid is fresh water.

5. The engineered structure according to claim 1, wherein said said gas situated between said plurality of parallel ridges and said at least two breaker ridges is air.

6. The engineered structure according to claim 1, wherein said said gas situated between said plurality of parallel ridges and said at least two breaker ridges is water vapor.

7. The engineered structure according to claim 1, further comprising at least one aperture defined within said surface of said solid object, and a source of pressurized gas configured to provide said gas to said volume defined by said at least two breaker ridges and said plurality of parallel ridges.

8. The engineered structure according to claim 7, further comprising a pressure monitoring device configured to measure a pressure of said gas.

9. The engineered structure according to claim 8, further comprising a pressure control device configured to control a pressure of said gas.

10. The engineered structure according to claim 1, wherein said second spacing dimension being at least a selected one of two, five, ten or more times greater than said first spacing dimension w.

11. An engineered structure configured to provide reduced drag force experienced by a solid object and a fluid having relative motion therebetween, comprising:
a surface of said solid object;
a plurality of posts extending from said surface of said solid object, said plurality of posts each having a width d and a height h, said plurality of posts being spaced apart by a first spacing dimension w, said plurality of posts extending along said surface of said solid object in a first direction for a predefined distance; and
at least two breaker posts situated between at least two of said plurality of posts, said at least two breaker posts being oriented along a line inclined at an angle to said first direction, said at least two breaker posts being situated apart from each other by a second spacing dimension, said at least two breaker posts and said plurality of posts configured to define a volume wherein a gas may be situated;
whereby said engineered structure is configured to provide a reduced drag force between said fluid and said solid object having said engineered structure when said fluid and said solid object are in a relative flow relationship as compared to a drag force that would be generated between said fluid and said solid object lacking the engineered structure when said fluid and said solid object are in a relative flow relationship.

12. The engineered structure according to claim 11, wherein said fluid is water.

13. The engineered structure according to claim 11, wherein said fluid is sea water.

14. The engineered structure according to claim 11, wherein said fluid is fresh water.

15. The engineered structure according to claim 11, wherein said said gas situated between said plurality of posts and said at least two breaker posts is air.

16. The engineered structure according to claim 11, wherein said said gas situated between said plurality of posts and said at least two breaker posts is water vapor.

17. The engineered structure according to claim 11, further comprising at least one aperture defined within said surface of said solid object, and a source of pressurized gas configured to provide said gas to said volume defined by said at least two breaker posts and said plurality of posts.

18. The engineered structure according to claim 17, further comprising a pressure monitoring device configured to measure a pressure of said gas.

19. The engineered structure according to claim 18, further comprising a pressure control device configured to control a pressure of said gas.

20. The engineered structure according to claim 11, wherein said second spacing dimension being at least a selected one of two, five, ten or more times greater than said first spacing dimension w.

21. A method of manufacturing an engineered structure configured to provide reduced drag force experienced by a solid object and a fluid having relative motion therebetween, comprising the steps of:
providing a solid object having a surface;
proving on said surface of said solid object a plurality of parallel ridges extending from said surface of said solid object, said plurality of parallel ridges each having a width d and a height h, said plurality of parallel ridges being spaced apart by a first spacing dimension w, said plurality of parallel ridges extending along said surface of said solid object for a predefined length l; and
providing on said surface of said solid object at least two breaker ridges situated between at least two of said plurality of parallel ridges, said at least two breaker ridges being oriented at an angle to said length of said at least two parallel ridges, said at least two breaker ridges being situated apart from each other by a second spacing dimension, said at least two breaker ridges and said plurality of parallel ridges configured to define a volume wherein a gas may be situated.

22. The method according to claim 21, wherein said parallel ridges and said breaker ridges are provided on a sheet substrate, and said sheet substrate is attached to said surface of said solid object.

23. A method of manufacturing an engineered structure configured to provide reduced drag force experienced by a solid object and a fluid having relative motion therebetween, comprising the steps of:
providing a solid object having a surface;
providing on said surface of said solid object a plurality of posts extending from said surface of said solid object, said plurality of posts each having a width d and a height h, said plurality of posts being spaced apart by a first spacing dimension w, said plurality of posts extending along said surface of said solid object in a first direction for a predefined distance; and
providing on said surface of said solid object at least two breaker posts situated between at least two of said plurality of posts, said at least two breaker posts being oriented along a line inclined at an angle to said first direction, said at least two breaker posts being situated apart from each other by a second spacing dimension, said at least two breaker posts and said plurality of posts configured to define a volume wherein a gas may be situated.

24. The method according to claim 23, wherein said posts and said breaker posts are provided on a sheet substrate, and said sheet substrate is attached to said surface of said solid object.
